(19) United States
(12) Patent Application Publication
(10) Pub. No.: US 2025/0379635 A1
(43) Pub. Date: Dec. 11, 2025

(54) METHOD AND DEVICE FOR BEAM MANAGEMENT IN COMMUNICATION SYSTEM

(71) Applicants: HYUNDAI MOTOR COMPANY, Seoul (KR); KIA CORPORATION, Seoul (KR); SEOUL NATIONAL UNIVERSITY R&DB FOUNDATION, Seoul (KR)

(72) Inventors: Gene Back Hahn, Hwaseong-si, Gyeonggi-do (KR); Young Kil Suh, Hwaseong-si, Gyeonggi-do (KR); Ui Hyun Hong, Hwaseong-si, Gyeonggi-do (KR); Bum Jun Kim, Seoul (KR); Jeonghyeon Kwon, Seoul (KR); Wan Choi, Seoul (KR)

(73) Assignees: HYUNDAI MOTOR COMPANY, Seoul (KR); KIA CORPORATION, Seoul (KR); SEOUL NATIONAL UNIVERSITY R&DB FOUNDATION, Seoul (KR)

(21) Appl. No.: 18/875,024

(22) PCT Filed: Aug. 8, 2023
(86) PCT No.: PCT/KR2023/011709

§ 371 Date: Dec. 13, 2024

(30) Foreign Application Priority Data
Aug. 8, 2022 (KR) 10-2022-0098472

(51) Int. Cl. H04B 7/06; H04B 17/309

(52) U.S. Cl. CPC H04B 7/06952; H04B 17/346

(57) ABSTRACT

An operation method of a first communication node may comprise the steps of: receiving, from a first transmission and reception point (TRP) and a second TRP, information of one or more candidate beams of each of the first TRP and the second TRP; transmitting, to the first TRP, the information of the one or more candidate beams of the second TRP; transmitting, to the second TRP, the information of the one or more candidate beams of the first TRP; receiving information of one or more beam combinations from the first TRP; transmitting, to the first TRP, information related to first measurement values for each beam combination corresponding to each of the one or more beam combinations; and receiving information of a first beam combination selected in the first TRP on the basis of the transmitted information related to the first measurement values for each beam combination.

### TECHNICAL FIELD

The present disclosure relates to a beam management technique in a communication system, and more particularly, to a beam management technique for beam-based communication between one or more base stations and one or more terminals in a communication system.

### BACKGROUND ART

With the development of information and communication technology, various wireless communication technologies are being developed. Representative wireless communication technologies include long-term evolution (LTE) and new radio (NR) defined as the 3rd generation partnership project (3GPP) standards. The LTE may be one of the 4th generation (4G) wireless communication technologies, and the NR may be one of the 5th generation (5G) wireless communication technologies.

In order to process rapidly increasing wireless data, the 5G NR communication or subsequent wireless communication technologies can support communication in relatively high frequency bands. For example, radio frequency bands used for wireless communication may be broadly classified into frequency range 1 (FR1) bands and frequency range 2 (FR2) bands. Here, the FR1 bands may refer to relatively low frequency bands of about 7 GHz or below. The FR2 bands may refer to relatively high frequency bands of about 7 GHz or above.

In a relatively high frequency band such as a 24-53 GHz band corresponding to the FR2 band, an unlicensed band, and a millimeter wave band, a path loss may occur at a relatively high level. In an exemplary embodiment of a communication system using a high frequency band, the path loss problem may be solved by using a large number of antennas to transmit and receive a wireless signal (or beam) with high antenna gain.

In an exemplary embodiment of a communication system, a network may include one or more base stations or one or more transmission and reception points (TRPs). In particular, a communication environment in which multiple TRPs exist may be referred to as ‘multi-TRP (MTRP)’. Multiple TRPs may support the same terminal. If each of the multiple TRPs independently performs a beam management procedure for beam-based communication with the terminal, a beam selected by each TRP may not guarantee an optimal beam from the terminal's perspective, which is receiving beams simultaneously from the multiple TRPs. Furthermore, a beam of one TRP may act as a strong interference to beams of other TRPs, leading to a beam failure. When a terminal performs beam management procedures with multiple TRPs in the MTRP environment, a joint beam management procedure that considers impact of one TRP's beam on beams formed by other TRPs may be required.

Matters described as the prior arts are prepared to promote understanding of the background of the present disclosure, and may include matters that are not already known to those of ordinary skill in the technology domain to which exemplary embodiments of the present disclosure belong.

### DISCLOSURE

### Technical Problem

The present disclosure provides a method and apparatus for signal transmission and reception that enhance beam transmission and reception performance based on multi-input multi-output (MIMO) technology, where radio signals are transmitted and received using a large number of antennas in a high-frequency band.

### Technical Solution

An operation method of a first communication node in a communication system, according to a first exemplary embodiment of the present disclosure, may comprise: receiving, from a first transmission and reception point (TRP) and a second TRP, information of one or more candidate beams of each of the first and second TRPs; transmitting, to the first TRP, information of the one or more candidate beams of the second TRP; transmitting, to the second TRP, information of the one or more candidate beams of the first TRP; receiving, from the first TRP, information of one or more beam combinations; transmitting, to the first TRP, information related to first measurement values for each beam combination corresponding to each of the one or more beam combinations; and receiving, from the first TRP, information of a first beam combination selected based on the information related to the first measurement values for each beam combination, wherein each of the one or more beam combinations may be configured as a combination of one beam of the one or more candidate beams of the first TRP and one beam of the one or more candidate beams of the second TRP.

The transmitting of the information related to the first measurement values for each beam combination may comprise: receiving first signals transmitted from the first and second TRPs, the first signals corresponding to each of the one or more beam combinations; performing a measurement operation on the received first signals; and transmitting, to the first TRP, the information related to the first measurement values for each beam combination, which is obtained at least based on the measurement operation, wherein in the receiving of the first signals, reception timings of the first signals transmitted from the first TRP and the first signals transmitted from the second TRP may be identical to each other.

In the receiving of the first signals, the first signals transmitted from the first TRP may be received based on a first period configured based on information of the one or more candidate beams of the first TRP, and the second signals transmitted from the second TRP may be received based on a second period configured based on information of the one or more candidate beams of the second TRP.

The transmitting of the information related to the first measurement values for each beam combination may comprise: receiving, from the second TRP, information of a first threshold value corresponding to the first measurement values; and transmitting, to the first TRP, the information of the first threshold value received from the second TRP and information of the first measurement values for each beam combination.

The first measurement values may be Signal to Interference plus Noise Ratio (SINR) values for the first signals, and the transmitting of the information related to the first measurement values for each beam combination may comprise: receiving the first signals transmitted from the first TRP, through a first panel corresponding to the first TRP in the first communication node; receiving the first signals transmitted from the second TRP, through a second panel corresponding to the second TRP in the first communication node; obtaining the first measurement values for each of the received first signals; mapping the obtained first measurement values to each of the one or more beam combinations to obtain information of the first measurement values for each beam combination; and transmitting, to the first TRP, at least the information of the first measurement values for each beam combination.

The operation method may further comprise: before receiving the information of the one or more candidate beams of each of the first and second TRPs, receiving, from the first TRP, information related to a transmission timing of the first signals of the first TRP; and transmitting, to the second TRP, information related to the transmission timing of the first signals of the first TRP. The operation method may further comprise: before receiving the information of the one or more beam combinations, transmitting, to the first TRP, information of one or more candidate beams of the first communication node, wherein the first beam combination selected by the first TRP may comprise a first beam among the one or more candidate beams of the first TRP, a second beam among the one or more candidate beams of the second TRP, and a third beam among the one or more candidate beams of the first communication node.

The operation method may further comprise: before receiving the information of the one or more beam combinations, transmitting, to the first TRP, information of one or more candidate beams of the first communication node, wherein the first beam combination selected by the first TRP may comprise at least a first beam among the one or more candidate beams of the first TRP, a second beam among the one or more candidate beams of the second TRP, and a third beam corresponding to the first TRP and a fourth beam corresponding to the second TRP among the one or more candidate beams of the first communication node.

The operation method may further comprise: after receiving the information of the first beam combination, transmitting information of the received first beam combination to the second TRP.

An operation method of a first transmission and reception point (TRP) in a communication system, according to a second exemplary embodiment of the present disclosure, may comprise: configuring one or more candidate beams of the first TRP; transmitting, to a first communication node, information of the one or more candidate beams of the first TRP; receiving, from the first communication node, information of one or more candidate beams of a second TRP; configuring one or more beam combinations; transmitting, to the first communication node, information of the one or more beam combinations; receiving, from the first communication node, information related to one or more first measurement values for one or more first signals respectively corresponding to the one or more beam combinations; selecting a first beam combination from among the one or more beam combinations based on the information related to the one or more first measurement values; and transmitting, to the first communication node, information of the selected first beam combination, wherein each of the one or more beam combinations may be configured as a combination of one beam of the one or more candidate beams of the first TRP and one beam of the one or more candidate beams of the second TRP.

The operation method may further comprise: before transmitting the information of the one or more candidate beams, transmitting, to the first communication node, information related to a transmission timing of the one or more first signals of the first TRP.

The operation method may further comprise, before configuring the one or more beam combinations, transmitting, to the first communication node, information on a transmission timing of the one or more first signals transmitted from the first TRP, the information on the transmission timing being used to adjust a transmission timing of the one or more first signals transmitted from the second TRP.

The first measurement values may be Signal to Interference plus Noise Ratio (SINR) values for the first signals, the information related to the one or more first measurement values may include information of a first threshold value corresponding to the one or more first measurement values, and information of the first measurement values for each beam combination, and the selecting of the first beam combination may comprise: identifying information of a second threshold value corresponding to the one or more first measurement values, which is predetermined by the first TRP; and selecting the first beam combination from among the one or more beam combinations based on the information of the first threshold value, the information of the second threshold value, and the information of the first measurement values for each beam combination.

The operation method may further comprise: before transmitting the information of the one or more beam combinations, receiving, from the first communication node, information of one or more candidate beams of the first communication node, wherein the first beam combination may comprise a first beam among the one or more candidate beams of the first TRP, a second beam among the one or more candidate beams of the second TRP, and a third beam among the one or more candidate beams of the first communication node.

The operation method may further comprise: before transmitting the information of the one or more beam combinations, receiving, from the first communication node, information of one or more candidate beams of the first communication node, wherein the first beam combination may comprise a first beam among the one or more candidate beams of the first TRP, a second beam among the one or more candidate beams of the second TRP, and a third beam corresponding to the first TRP and a fourth beam corresponding to the second TRP among the one or more candidate beams of the first communication node.

A first communication node in a communication system, according to a third exemplary embodiment of the present disclosure, may comprise: at least one processor, wherein the at least one processor may cause the first communication node to perform: receiving, from a first transmission and reception point (TRP) and a second TRP, information of one or more candidate beams of each of the first and second TRPs; transmitting, to the first TRP, information of the one or more candidate beams of the second TRP; transmitting, to the second TRP, information of the one or more candidate beams of the first TRP; receiving, from the first TRP, information of one or more beam combinations; transmitting, to the first TRP, information related to first measurement values for each beam combination corresponding to each of the one or more beam combinations; and receiving, from the first TRP, information of a first beam combination selected based on the information related to the first measurement values for each beam combination, wherein each of the one or more beam combinations may be configured as a combination of one beam of the one or more candidate beams of the first TRP and one beam of the one or more candidate beams of the second TRP.

In the transmitting of the information related to the first measurement values for each beam combination, the at least one processor may cause the first communication node to perform: receiving first signals transmitted from the first and second TRPs, the first signals corresponding to each of the one or more beam combinations; performing a measurement operation on the received first signals; and transmitting, to the first TRP, the information related to the first measurement values for each beam combination, which is obtained at least based on the measurement operation, wherein in the receiving of the first signals, reception timings of the first signals transmitted from the first TRP and the first signals transmitted from the second TRP may be identical to each other.

In the transmitting of the information related to the first measurement values for each beam combination, the at least one processor may cause the first communication node to perform: receiving, from the second TRP, information of a first threshold value corresponding to the first measurement values; and transmitting, to the first TRP, the information of the first threshold value received from the second TRP and information of the first measurement values for each beam combination.

The first measurement values may be Signal to Interference plus Noise Ratio (SINR) values for the first signals, and in the transmitting of the information related to the first measurement values for each beam combination, the at least one processor may cause the first communication node to perform: receiving the first signals transmitted from the first TRP, through a first panel corresponding to the first TRP in the first communication node; receiving the first signals transmitted from the second TRP, through a second panel corresponding to the second TRP in the first communication node; obtaining the first measurement values for each of the received first signals; mapping the obtained first measurement values to each of the one or more beam combinations to obtain information of the first measurement values for each beam combination; and transmitting, to the first TRP, at least the information of the first measurement values for each beam combination.

The at least one processor may further cause the first communication node to perform: before receiving the information of the one or more candidate beams of each of the first and second TRPs, receiving, from the first TRP, information related to a transmission timing of the first signals of the first TRP; and transmitting, to the second TRP, information related to the transmission timing of the first signals of the first TRP.

### Advantageous Effects

According to exemplary embodiments of the beam management method and device in the communication system, a beam combination for communication between the terminal and multiple TRPs can be determined based on signaling procedures between the terminal and the multiple TRPs. Information on each TRP's candidate beams (or beam candidate group) can be transmitted and received between the terminal and the multiple TRPs. Through this, one or more beam combinations can be determined. Among the one or more beam combinations thus determined, one beam combination can be selected based on measurement results at the terminal. In the above-described manner, the beam adjustment procedure for communication between the terminal and multiple TRPs can be facilitated.

### DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3 is a sequence chart describing a first exemplary embodiment of a beam management method in a communication system.

FIG. 4 is a sequence chart describing a second exemplary embodiment of a beam management method in a communication system.

FIG. 5 is a sequence chart for describing a third exemplary embodiment of a beam management method in a communication system.

FIG. 6A and FIG. 6B are sequence charts for describing fourth and fifth exemplary embodiments of a beam management method in a communication system.

FIGS. 7A and 7B are sequence charts for describing sixth and seventh exemplary embodiments of a beam management method in a communication system.

FIG. 8 is a flowchart for describing an eighth embodiment of a beam management method in a communication system.

FIGS. 9A and 9B are sequence charts for describing ninth and tenth exemplary embodiments of a beam management method in a communication system.

FIG. 10A and FIG. 10B are sequence charts for describing eleventh and twelfth exemplary embodiments of a beam management method in a communication system.

FIG. 11 is a sequence chart for describing a first exemplary embodiment of a beam adjustment method in a communication system.

FIG. 12 is a sequence chart for describing a second exemplary embodiment of a beam adjustment method in a communication system.

FIG. 13 is a flowchart for describing a first exemplary embodiment of a beam adjustment method in a communication system.

FIG. 14 is a flowchart for describing a second exemplary embodiment of a beam adjustment method in a communication system.

### MODE FOR INVENTION

Exemplary embodiments of the present disclosure are disclosed herein. However, specific structural and functional details disclosed herein are merely representative for purposes of describing exemplary embodiments of the present disclosure. Thus, exemplary embodiments of the present disclosure may be embodied in many alternate forms and should not be construed as limited to exemplary embodiments of the present disclosure set forth herein.

Accordingly, while the present disclosure is capable of various modifications and alternative forms, specific exemplary embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular exemplary embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, B5G mobile communication network (6G communication network, etc.), or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present disclosure, the base station may refer to an access point, radio access station, node B (NB), evolved node B (eNB), base transceiver station, mobile multi-hop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

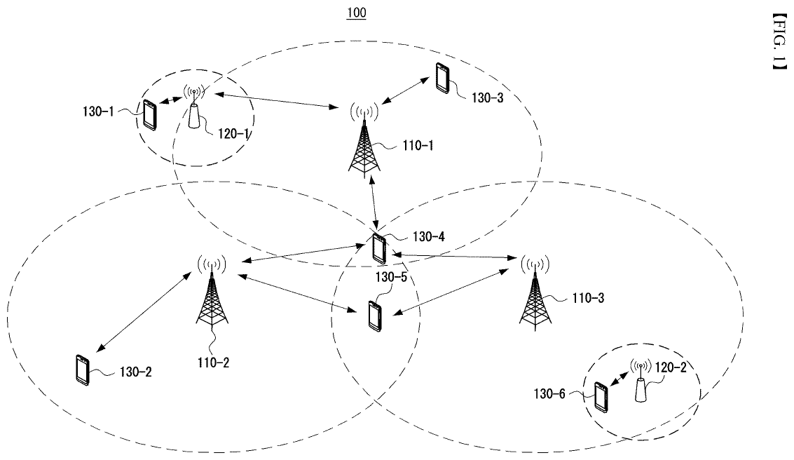

FIG. 1 is a conceptual diagram illustrating an exemplary embodiment of a communication system.

As shown in FIG. 1, a communication system 100 may comprise a plurality of communication nodes 110-1, 110-2, 110-3, 120-1, 120-2, 130-1, 130-2, 130-3, 130-4, 130-5, and 130-6. Also, the communication system 100 may further comprise a core network (e.g. a serving gateway (S-GW), a packet data network (PDN) gateway (P-GW), and a mobility management entity (MME)). When the communication system 100 is a 5G communication system (e.g. New Radio (NR) system), the core network may include an access and mobility management function (AMF), a user plane function (UPF), a session management function (SMF), and the like.

The plurality of communication nodes 110 to 130 may support communication protocols defined in the 3rd generation partnership project (3GPP) technical specifications (e.g. LTE communication protocol, LTE-A communication protocol, NR communication protocol, or the like). The plurality of communication nodes 110 to 130 may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform-spread-OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter band multi-carrier (FBMC) based communication protocol, universal filtered multi-carrier (UFMC) based communication protocol, space division multiple access (SDMA) based communication protocol, or the like. Each of the plurality of communication nodes may have the following structure.

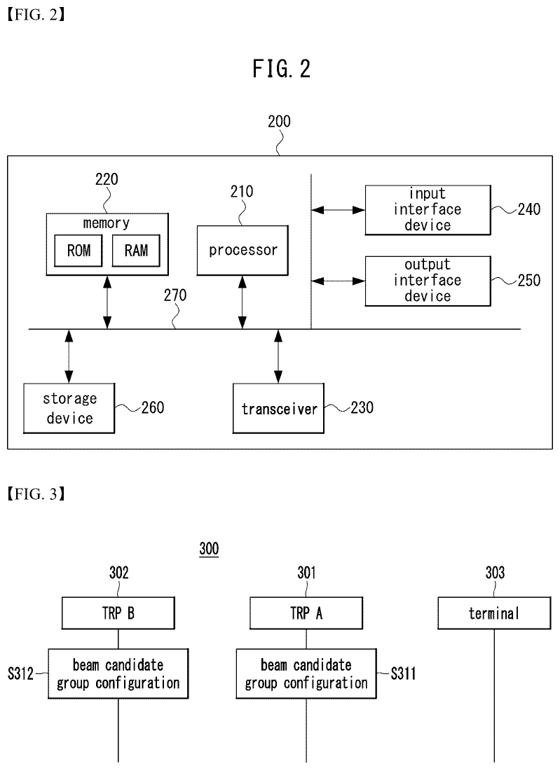

FIG. 2 is a block diagram illustrating an exemplary embodiment of a communication node constituting a communication system.

As shown in FIG. 2, an apparatus 200 may comprise at least one processor 210, a memory 220, and a transceiver 230 connected to the network for performing communications. Also, the apparatus 200 may further comprise an input interface device 240, an output interface device 250, a storage device 260, and the like. The respective components included in the apparatus 200 may communicate with each other as connected through a bus 270.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to the cell coverage of the first base station 110-1. Also, the second terminal 130-2, the fourth terminal 130-4, and the fifth terminal 130-5 may belong to the cell coverage of the second base station 110-2. Also, the fifth base station 120-2, the fourth terminal 130-4, the fifth terminal 130-5, and the sixth terminal 130-6 may belong to the cell coverage of the third base station 110-3. Also, the first terminal 130-1 may belong to the cell coverage of the fourth base station 120-1, and the sixth terminal 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), gNB, advanced base station (ABS), high reliability-base station (HR-BS), base transceiver station (BTS), radio base station, radio transceiver, access point (AP), access node, radio access station (RAS), mobile multihop relay-base station (MMR-BS), relay station (RS), advanced relay station (ARS), high reliability-relay station (HR-RS), home NodeB (HNB), home eNodeB (HeNB), road side unit (RSU), radio remote head (RRH), transmission point (TP), transmission and reception point (TRP), or the like.

Each of the plurality of terminals 130-1, 130-2, 130-3, 130-4, 130-5, and 130-6 may be referred to as user equipment (UE), terminal equipment (TE), advanced mobile station (AMS), high reliability-mobile station (HR-MS), terminal, access terminal, mobile terminal, station, subscriber station, mobile station, portable subscriber station, node, device, on-board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support a multi-input multi-output (MIMO) transmission (e.g. single-user MIMO (SU-MIMO), multi-user MIMO (MU-MIMO), massive MIMO, or the like), a coordinated multipoint (CoMP) transmission, a carrier aggregation (CA) transmission, a transmission in unlicensed band, a device-to-device (D2D) communication (or, proximity services (ProSe)), an Internet of Things (IoT) communication, a dual connectivity (DC), or the like. Here, each of the plurality of terminals 130-1, 130-2, 130-3, 130-4, 130-5, and 130-6 may perform operations corresponding to operations of the plurality of base stations 110-1, 110-2, 110-3, 120-1, and 120-2, operations supported by the plurality of base stations 110-1, 110-2, 110-3, 120-1, and 120-2, or the like. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

Each of the first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the COMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, beam management methods in a communication system will be described. Even when a method (e.g. transmission or reception of a data packet) performed at a first communication node among communication nodes is described, the corresponding second communication node may perform a method (e.g. reception or transmission of the data packet) corresponding to the method performed at the first communication node. That is, when an operation of a terminal is described, the corresponding base station may perform an operation corresponding to the operation of the terminal. Conversely, when an operation of the base station is described, the corresponding terminal may perform an operation corresponding to the operation of the base station.

In an exemplary embodiment of a communication system, a network may include one or more base stations or one or more transmission and reception points (TRPs). In particular, a communication environment in which multiple TRPs exist may be referred to as ‘multi-TRP (MTRP)’. An MTRP technique may refer to a technique in which a base station performs communication with a terminal by utilizing multiple TRPs that are physically separated. Based on the MTRP technique, a problem of reduced Quality-of-Service (QOS) due to a cell-edge terminal being far from the base station and a problem of inter-cell interference from base stations located in different cells can be solved. Based on the MTRP technique, an additional communication path can be secured in an environment in which a Non Line-of-Sight (NLOS) path is limited, such as a millimeter wave band.

The MTRP technique may be classified into a Coherent Joint Transmission (CJT) scheme and a Non-Coherent Joint Transmission (NCJT) scheme. In the CJT scheme, TRPs may cooperate with each other to support a single terminal in a synchronized manner. In the NCJT scheme, multiple TRPs may perform scheduling, precoding matrix selection, modulation coding scheme (MCS) determination, and the like without cooperation among themselves in a situation where they support a single terminal. In order to support the MTRP technique, PDCCH, PUCCH, PUSCH, inter-cell operation, beam management, and the like may need to be enhanced.

In an MTRP environment, beam indications for multiple beams may be performed to the terminal. In addition, in the MTRP environment, the terminal may receive multiple beams and report their performance. Here, in order to select an optimal beam (or beam combination) by considering interaction between beams formed by multiple TRPs in a beam management process, transmission times or transmission patterns of reference signals transmitted by the respective TRPs may need to match. In addition, in order to measure performance of each beam combination, a beam switching period of each TRP may need to be determined by considering the number of candidate beams of other TRPs. In order to perform a joint beam management process in the MTRP environment, a technique may be required to match CSI-RS transmission times and transmission patterns between TRPs and to enable each TRP to efficiently switch beams.

In an exemplary embodiment of a communication system, extension of a unified transmission configuration indication (TCI) framework may be considered. In the extension of the unified TCI framework, MTRP environments such as intra-cell MTRP and inter-cell MTRP may be considered. In the MTRP environment, a simultaneous transmission across multi-panel (STxMP) scheme may be applied.

At least in a unified TCI framework for single-downlink control information (S-DCI) based MTRP, a TCI field within a DCI format 1_1/1_2 may indicate multiple (joint, DL, UL, etc.) TCI states in one CC/BWP. Here, the DCI format 1_1/1_2 may be a DCI format with or without DL assignment. At least in the unified TCI framework for single-DCI based MTRP, a TCI field within a DCI format 1_1/1_2 may indicate a set of CCs/BWPs in a CC list. Here, mapping of TCI state ID(s) to TCI code points may be performed in various manners. For example, possible combinations of IDs of TCI states such as joint, DL and/or UL may be mapped to TCI code points.

The maximum number of Medium Access Control (MAC) Control Element (CE) activated TCI code points (e.g. 8 code points) may be increased, decreased or maintained. The maximum number of bits in the TCI field (e.g. 3 bits or more) may be increased, decreased or maintained.

In a unified TCI framework for multi-DCI (M-DCI) based MTRP, the following may be considered for TCI state update.
The TCI state update scheme for S-DCI based MTRP may be used identically.
A TCI field within a DCI format 1_1/1_2, which is associated with one of CORESETPoolIndex values, may be used to indicate all (joint, DL, UL, etc.) TCI states corresponding to the same CORESETPoolIndex value. Alternatively, a TCI field within a DCI format 1_1/1_2 may be used to indicate all (joint, DL, UL, etc.) TCI states corresponding to multiple CORESETPoolIndex values. Alternatively, a TCI field within a DCI format 1_1/1_2, which is associated with one of CORESETPoolIndex values, may be used to indicate all (joint, DL, UL, etc.) TCI states corresponding to a different CORESETPoolIndex value. Each CORESETPoolIndex value and its TCI state(s) may be associated with each other in various manners.

In a unified TCI framework for S-DCI based MTRP, the following may be considered to map or associate TCI states such as joint/DL to PDCCH reception.
RRC configuration may be used to indicate mapping/association between a configured or indicated (joint/DL) TCI state and one CORESET or CORESET group.
RRC configuration may be used to indicate mapping/association between a configured or indicated (joint/DL) TCI state and one search space set.
MAC-CE may be used to indicate mapping/association between an active or indicated (joint/DL) TCI state and one CORESET or CORESET group.
DCI may be used to indicate mapping/association between an indicated (joint/DL) TCI state and one CORESET or CORESET group.
Fixed mapping/association rules may be used.

If groupBasedBeamReporting-r17 in a higher layer parameter CSI-ReportConfig is configured, and repetition for a corresponding resource set is set to ‘on’, CSI-RS Resource Indicator(s) (CRI(s)) may not be reported.

In an M-DCI based inter-cell MTRP environment, an SSB associated with an additional PCI may be configured as one NBI-RS in an NBI-RS set. The NBI-RS set may be associated with a BFD-RS set associated with the additional PCI.

If groupBasedBeamReporting-r17 in the higher layer parameter CSI-ReportConfig is configured, configuration of the same or different CSI-RS triggering offset values for two different CSI resource sets may be supported.

If groupBasedBeamReporting-r17 in the higher layer parameter CSI-ReportConfig is configured, the same or different repetition value(s) for different CSI resource sets may be set for the terminal. The terminal may report CRI regardless of whether the repetition value(s) are set to ‘on’.

In an MTRP environment according to an exemplary embodiment of a communication system, the CJT scheme and the NCJT scheme may be determined according to a cell environment where the TRPs currently exist, backhaul link connectivity, etc. In the MTRP environment, a group-based beam reporting scheme may be used in which beams formed by multiple TRPs are grouped into one group, and the terminal reports performance for each group to the TRP(s).

In an MTRP environment according to an exemplary embodiment of a communication system, a simultaneous transmission across multi-panel (STxMP) scheme may be applied.

In an MTRP environment according to an exemplary embodiment of a communication system, a beam management procedure between a terminal with one panel or multiple panels and multiple TRPs may be performed. The terminal may assign one or more TRPs to one of its panels (e.g. TRP A-UE panel A, TRP B-UE panel B, etc.). The terminal may report performance for each beam group to the TRP based on the group-based beam reporting scheme. Here, multiple TRPs may be assigned to one panel of the terminal, or multiple panels of the terminal may be assigned to one TRP.

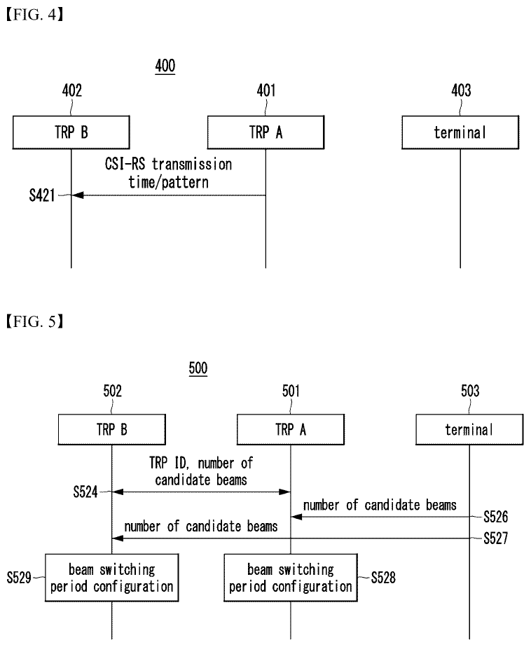

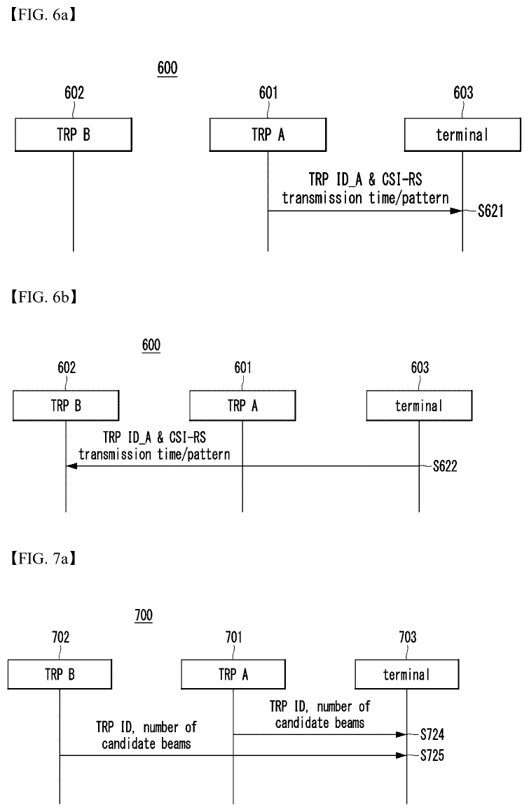

When the TRP A and TRP B independently perform beam management procedures through the UE panel A and UE panel B, it may not be guaranteed that a beam selected from each TRP is an optimal beam from the perspective of the terminal. In addition, a beam of one TRP may cause high interference with a beam of another TRP, resulting in a beam failure in one or more TRPs. In the MTRP environment, when a terminal performs beam management procedures with multiple TRPs, a joint beam management procedure that considers influence of a beam formed by one TRP on a beam formed by another TRP may be required. Specifically, in order to support this, TRPs may transmit and receive information on TRP IDs, number of candidate beams, CSI-RS transmission times and transmission patterns, and the like. Such information transmission and reception may be performed via a backhaul between the TRPs or between base stations connected to the TRPs (See FIGS. 4 and 5). Alternatively, such information transmission and reception may be performed via a terminal (See FIG. 6A to 7B). In addition, based on such information transmission and reception, a beam switching period may be determined, performance of each beam combination may be measured, and an optimal beam combination may be selected.

In an exemplary embodiment of a communication system, a beam management process may be performed based on steps such as initial establishment, beam adjustment, and beam recovery processes. The beam management process may be performed by measuring the performance of each beam while switching beams based on beam sweeping, and selecting a beam with the best performance. In the initial establishment process, a beam direction may be primarily determined using a wide beam. In the beam adjustment process, an optimal beam may be determined using more detailed beamforming. In the beam recovery process, if a certain level of performance is not satisfied when communicating using a previously determined beam, a new beam may be selected when the terminal transmits a Beam Failure Detection (BFD) to the TRP.

At least some of exemplary embodiments to be described with reference to FIGS. 3 to 14 may be described based on a situation where two TRPs (hereinafter, TRP A and TRP B) support a single terminal in an MTRP environment, and an approximate beam direction is determined for the two TRPs through an initial establishment process. After the initial establishment process, a joint beam adjustment procedure may be performed to select an optimal beam for both TRPs, considering the influence of the beam formed by each of the TRP A and TRP B on the beam of the other TRP when communicating with the terminal.

FIG. 3 is a sequence chart describing a first exemplary embodiment of a beam management method in a communication system.

As shown in FIG. 3, a communication system 300 may include one or more TRPs and one or more terminals. For example, the communication system 300 may include a TRP A 301, a TRP B 302, and a terminal 303. In the communication system 300, the TRP A 301 and TRP B 302 may be connected to the same base station. Alternatively, in the communication system 300, the TRP A 301 and TRP B 302 may be connected to different base stations. The TRP A 301 and TRP B 302 may support the same terminal 303. Hereinafter, in describing the first exemplary embodiment of the beam management method in the communication system with reference to FIG. 3, descriptions redundant with those described with reference to FIGS. 1 and 2 may be omitted.

In the first exemplary embodiment of the beam management method, a coarse or approximate beam direction may be determined through an initial establishment procedure between the TRPs 301 and 302 and the terminal 303. Based on the beam direction determination result, a beamforming direction may be configured through a fine beam direction configuration procedure or beam adjustment procedure. Accordingly, an optimal beam (or beam combination) for communication between the TRPs 301 and 302 and the terminal 303 may be selected.

The TRPs 301 and 302 may configure a beam candidate group to be utilized in the beam adjustment procedure for communication with the terminal 303. For example, the beam candidate group of each of the TRPs 301 and 302 may be configured as shown in Table 1.

TABLE 1

| | | Number of |
|---|---|---|
| TRP | Beam candidate group | candidate beams |
| TRP A | beam #A-1, beam #A-2, beam #A-3 | 3 |
| TRP B | beam #B-1, beam #B-2, beam #B- | 5 |
| | 3, beam #B-4, beam #B-5 | |

(Specifically, the TRP A 301 may perform a beam candidate group configuration operation (S311). The beam candidate group of the TRP A 301 configured in step S311 may include three candidate beams. Each of the three candidate beams included in the beam candidate group of the TRP A 301 may be referred to as a beam #A-1, beam #A-2, and beam #A-3. The TRP B 302 may perform a beam candidate group configuration operation (S312). The beam candidate group of the TRP B 302 configured in step S312 may include five candidate beams. The five candidate beams included in the beam candidate group of the TRP B 302 may be referred to as a beam #B-1, beam #B-2, beam #B-3, beam #B-4, and beam #B-5. This is merely an example for convenience of description, and the first exemplary embodiment of the beam management method in the communication system is not limited thereto. For example, the beam candidate group configuration result shown in Table 1 may be extended to an exemplary embodiment in which the TRP A 301 configures N_A candidate beams and the TRP B 302 configures N_B candidate beams. Here, N_A and N_B may be natural numbers.

Based on the number of candidate beams configured in each of the TRPs 301 and 302, the number of combinations (or ‘beam combinations’) of beams formed by the TRPs 301 and 302 may be determined. For example, if the TRP A 301 configures three candidate beams and the TRP B 302 configures five candidate beams, the number of combinations of beams formed by the TRPs 301 and 302 may be 15. If the TRP A 301 configures N_A candidate beams and the TRP B 302 configures N_B candidate beams, the number of combinations of beams formed by the TRPs 301 and 302 may be (N_A*N_B).

Based on the first exemplary embodiment of the beam management method in the communication system, one or more beam combinations may be configured. Procedures for selecting an optimal beam combination with the best performance among the configured beam combinations may be performed. For example, at least some of the communication nodes 301, 302, and 303 included in the communication system 300 may perform operations according to at least some of the second to twelfth exemplary embodiments of the beam management method in the communication system to be described later. Accordingly, an optimal beam combination for beam-based communication between the TRPs 301 and 302 and the terminal 303 may be selected.

Hereinafter, with reference to FIGS. 4 and 5, exemplary embodiments will be described based on a situation in which a backhaul is formed between TRPs or between base stations connected to the TRPs in the MTRP environment, and information is transmitted and received between the TRPs via the backhaul.

FIG. 4 is a sequence chart describing a second exemplary embodiment of a beam management method in a communication system.

As shown in FIG. 4, a communication system 400 may include one or more TRPs and one or more terminals. For example, the communication system 400 may include a TRP A 401, a TRP B 402, and a terminal 403. In the communication system 400, the TRP A 401 and TRP B 402 may be connected to the same base station. The TRP A 401 and TRP B 402 may perform information transmission and reception to and from each other via a backhaul, etc. The TRP A 401 and TRP B 402 may support the same terminal 403. Hereinafter, in describing the second exemplary embodiment of the beam management method in the communication system with reference to FIG. 4, descriptions redundant with those described with reference to FIGS. 1 to 3 may be omitted.

In a multi-TRP (i.e. MTRP) environment, multiple TRPs may transmit channel state information (CSI)-reference signals (RSS) simultaneously at a specific time. In this case, the terminal may receive the CSI-RSs transmitted from the TRPs and perform measurements for performance verification for all possible beam combinations. For this purpose, procedures for the TRPs to confirm or match CSI-RS transmission patterns between the TRPs and/or procedures for each of the TRPs to appropriately configure a beam switching period may be required.

In the second exemplary embodiment of the beam management method in the communication system, if it is determined that an initial establishment process is completed and a joint beam adjustment process is started, an operation may be performed in which the TRP A acting as a reference TRP transmits information on its CSI-RS transmission time and transmission pattern to the TRP B via the backhaul. The process illustrated in FIG. 4 may be performed in a manner in which another TRP matches its CSI-RS transmission time and transmission pattern to those of the TRP A acting as the reference TRP. Alternatively, all TRPs may select new CSI-RS transmission times and transmission patterns based on another TRP or through cooperation between the TRPs. For this purpose, a process in which all TRPs exchange their CSI-RS transmission times and transmission patterns with other TRPs may be additionally considered.

In the second exemplary embodiment of the beam management method in the communication system, a reference TRP among the TRPs 401 and 402 connected to the same base station (not shown) may be determined. For example, the TRP A 401 may be determined as a reference TRP. The TRP A 401, which is the reference TRP, may transmit information to the TRP B 402 through a link between the TRPs 401 and 402 or a backhaul between base stations connected to the TRPs 401 and 402. For example, the TRP A 401 may transmit information on a transmission time, transmission pattern, etc. of a first reference signal to the TRP B 402 (S421). The TRP B 402 may receive the information on the transmission time, transmission pattern, etc. of the first reference signal transmitted from the TRP A 401 (S421). Here, the first reference signal may be a CSI-RS. The information transmission operation according to step S421 may be expressed, for example, as in Table 2.

TABLE 2

| Path | Delivered information |
|---|---|
| TRP A → TRP B | CSI-RS transmission time and transmission |
| | pattern of TRP A |

Although FIG. 4 shows the exemplary embodiment in which the TRP A 401 is determined as a reference TRP, this is merely an example for convenience of description, and the second exemplary embodiment of the beam management method in the communication system is not limited thereto. For example, the base station (or network, etc.) may determine a reference TRP according to an order of TRP IDs. On the other hand, the base station may determine a TRP with a higher (or lower) resource utilization ratio as a reference TRP, thereby allowing TRPs with more available resources to align with the reference TRP in terms of resource utilization. Alternatively, the base station may use a method of selecting a reference TRP according to other situations or criteria and allowing other TRP(s) match CSI-RS transmission time(s) and transmission pattern(s) to those of the reference TRP.

The TRP B 402 receiving the information on the CSI-RS transmission time and transmission pattern of the TRP A 401 may transmit a CSI-RS at the same time as the TRP A 401 by utilizing the received information. In addition, a joint beam adjustment process that selects an optimal beam combination by considering influence of a beam formed by each TRP on other TRPs based thereon may be performed later. In the present disclosure, assuming the situation of FIG. 4 in which there are two TRPs communicating with the terminal 403, the TRP A 401 transmits information on its CSI-RS transmission time and transmission pattern to only one TRP, but when there are three or more TRPs communicating with the terminal 403, the reference TRP may transmit information on its CSI-RS transmission time and transmission pattern to all other TRPs communicating with the terminal 403. As a result, FIG. 4 shows a process in which the reference TRP transmits information on its CSI-RS transmission time and transmission pattern to other TRPs, and the other TRPs match their CSI-RS transmission times and transmission patterns to the reference TRP based on the information received from the reference TRP. In addition, considering a case in which it is difficult for other TRPs to transmit CSI-RS using the same transmission time and pattern as the CSI-RS transmission time and transmission pattern of the reference TRP, in the process in FIG. 4, the TRP B 402 may also transmit information on its CSI-RS to the TRP A 401, and a new CSI-RS transmission time and transmission pattern may be selected based on an agreement between the TRP A 401 and TRP B 402 regarding the CSI-RS transmission time and transmission pattern.

FIG. 5 is a sequence chart for describing a third exemplary embodiment of a beam management method in a communication system.

As shown in FIG. 5, a communication system 500 may include one or more TRPs and one or more terminals. For example, the communication system 500 may include a TRP A 501, a TRP B 502, and a terminal 503. In the communication system 500, the TRP A 501 and TRP B 502 may be connected to the same base station. The TRP A 501 and TRP B 502 may perform information transmission and reception to and from each other via a backhaul, etc. The TRP A 501 and TRP B 502 may support the same terminal 503. Hereinafter, in describing the third exemplary embodiment of the beam management method in the communication system with reference to FIG. 5, descriptions redundant with those described with reference to FIGS. 1 to 4 may be omitted.

In the third exemplary embodiment of the beam management method in the communication system, the TRP A and TRP B may transmit information on their TRP IDs and information on candidate beams (e.g. the number of candidate beams) to each other. Then, a procedure may be performed in which the terminal transmits information on the number of its candidate beams to all TRPs, and then each TRP determines the entire beam combinations based on the number of candidate beams of other TRPs and the number of candidate beams of the terminal, which are received by each TRP, and configures its beam switching period.

In the third exemplary embodiment of the beam management method in the communication system, the TRP A 501 and TRP B 502 may transmit and receive information on TRP IDs and information on candidate beams (e.g. the number of candidate beams) to each other (S524). The terminal 503 may transmit information on its candidate beam (e.g. the number of candidate beams) to the TRP A 501 and TRP B 502 (S526, S527). The TRP A501 and TRP B 502 may each configure their own beam switching periods (S528, S529).

Specifically, the TRP A 501 and TRP B 502 may transmit information on their own TRP IDs and information on the number of candidate beams to other TRPs via a backhaul between the TRPs or between base stations (not shown) connected to the TRPs, and the terminal 503 may transmit information on the number of its own candidate beams to all the TRPs 501 and 502. This procedure may be performed identically or similarly to Table 3 below.

TABLE 3

| Path | TRP ID | Delivered information |
|---|---|---|
| TRP A → TRP B | TRP ID_A | Number of candidate |
| | | beams of TRP A |
| TRP B → TRP A | TRP ID_B | Number of candidate |
| | | beams of TRP B |
| Terminal → TRP A, | X | Number of candidate |
| TRP B | | beams of terminal |

In addition, each of the TRPs 501 and 502 may identify the entire beam combinations based on the numbers of candidate beams which are received from other TRPs and the terminal, and then configure its own beam switching period. This procedure may be performed identically or similarly to Table 4 below.

TABLE 4

| TRP | Beam switching period |
|---|---|
| TRP A | 5 |
| TRP B | 1 |

Since FIG. 5 assumes that there are two TRPs communicating with the terminal, it shows a situation where each TRP transmits information on its TRP ID and information on the number of its candidate beams to only one other TRP. However, when there are three or more TRPs communicating with the terminal, each TRP may transmit information on its TRP ID and information on the number of its candidate beams to all other TRPs communicating with the terminal. The process of each TRP transmitting information on its TRP ID and information on the number of its candidate beams to other TRPs may be performed via a backhaul between the TRPs or between base stations connected to the TRPs, as in FIG. 4. Thereafter, each TRP may determine the entire beam combination based on the numbers of candidate beams received from other TRPs and the terminal. Since FIG. 5 assumes that the terminal has one candidate beam, the TRP A may know that the total number of beam combinations is 15 based on its own candidate beam number of 3 and TRP B's candidate beam number of 5 received from the TRP B. Furthermore, the TRP A may know that the number of different beam combinations that one of its candidate beams can form with beams of another TRP is 5. In order to measure performance for all beam combinations that can be formed during the joint beam adjustment process, it is necessary to configure an appropriate beam switching period at each TRP. In the present disclosure, two methods for configuring the beam switching period may be considered: 1) a method in which all TRPs exchange information on the numbers of their respective candidate beams, and then configure the beam switching periods according to a predetermined sequence announced by the reference TRP, and 2) a method in which all TRPs excluding the reference TRP transmit information on the numbers of their respective candidate beams to the reference TRP, and the reference TRP calculates appropriate beam switching periods for the respective TRPs based on the numbers of candidate beams of all the TRPs and transmits the calculated beam switching periods to all the other TRPs.

For example, in a situation in which three TRPs, TRP A, TRP B, and TRP C communicate with the terminal, it may be assumed that the numbers of candidate beams of the TRPs are 3, 4, and 5, respectively. In the case where there are three or more TRPs, for example, if an order of the TRPs is the TRP A, TRP B, and TRP C, the TRP C may configure its beam switching period to 1, the TRP B may configure its beam switching period corresponding to the number of beams of the TRP C, and the TRP A may configure its beam switching period corresponding to the number of beam combinations of the TRP B and TRP C.

In the case of method 1), the TRP A acting as the reference TRP may determine an order of the TRPs, and transmit information on beam switching priorities of the TRPs to all TRPs via a backhaul between the TRPs or between base stations connected to the TRPs. Then, after the three TRPs exchange information on the numbers of their candidate beams via the backhaul between the TRPs or between base stations connected to the TRPs, each TRP may determine its own beam switching period based on the numbers of beams of all the TRPs and the beam switching priorities of the TRPs. In other words, the TRP A may configure its beam switching period to 20, the TRP B may configure its beam switching period to 5, and the TRP C may configure its beam switching period to 1.

In the case of method 2), all TRPs excluding the reference TRP (i.e. TRP B and TRP C) may transmit information on the numbers of their candidate beams to the reference TRP (i.e. TRP A) via a backhaul between the TRPs or base stations connected to the TRPs. The TRP A may configure beam switching periods for all the TRPs based on the number of its own beams and the numbers of beams of other TRPs it received, and transmit information on the beam switching periods to other TRPs via the backhaul between the TRPs or base stations connected to the TRPs. Since the TRP A knows the numbers of beams of all the TRPs, for example, the TRP A may configure the TRP C′s beam switching period to 1, the TRP B's beam switching period to 5, configure the TRP A's beam switching period to 20, and then transmit information on the configured beam switching periods to all the TRPs via the backhaul between the TRPs or base stations connected to the TRPs.

After all the TRPs configure their beam switching periods, if a process is needed in which all the TRPs determine whether their beam switching periods are properly configured, all the TRPs may transmit information on their configured beam switching periods to the reference TRP via the backhaul between the TRPs or between base stations connected to the TRPs, and the reference TRP may determine whether all the TRPs have properly configure their beam switching periods based on the beam switching periods received from other TRPs and the beam switching priorities of the TRPs.

In the example of the present disclosure, when each TRP configures its beam switching period, after determining the numbers of candidate beams of other TRPs, the TRP B may configure its beam switching period to 1, and the TRP A may configure its beam switching period to 5 which is the number of candidate beams of the TRP B. Assuming a case where the terminal has multiple beams instead of just one, in the same manner as the environment where there are three TRPs, for example, if the beam switching priorities are set to an order of the TRP A, TRP B, and the terminal, the terminal may configure its beam switching period to 1, the TRP B may configure its beam switching period corresponding to the number of beams of the terminal, and the TRP A may configure its beam switching period corresponding to the number of beam combinations of the TRP B and the terminal. In the joint beam adjustment process of FIG. 5, the TRP A may repeat one beam 5 times identically and then change to another beam, and the TRP B may change to a different beam every time it transmits a beam. In addition, since the TRP A and TRP B can determine the number of total beam combinations based on the numbers of candidate beams of other TRPs received previously, the TRP A may determine that the reference signal transmission for the entire beam combinations is complete after performing beam switching twice and the TRP B may determine that the reference signal transmission for the entire beam combinations is complete after performing beam switching 14 times. In case that the configured beam switching periods need to be transmitted to the terminal, the information on the configured beam switching periods may be transmitted to the terminal by transmitting the set repetition number of beam(s) using information of ‘ENUMERATED {on, off}’ in a parameter repetition within a NZP-CSI-ResourceSet IE through RRC reconfiguration defined in the existing standard, or the information on the configured beam switching periods may be transmitted to the terminal by newly defining a parameter nrofRepetition, which is information on how many times one beam is repeated in the NZP-CSI-RS-ResourceSet IE. Alternatively, it may be transmitted to the terminal through DCI or other new RRC signaling.

According to the operations disclosed in FIG. 4 and FIG. 5, a TRP corresponding to a reference TRP may transmit information on its own CSI-RS transmission timing (i.e. transmission time and transmission pattern) to other TRPs via a backhaul between the TRPs or between base stations connected to the TRP, so that CSI-RS transmission times and transmission patterns of all the TRPs communicating with the terminal may be matched to its own CSI transmission time and pattern. In addition, after all TRPs communicating with the terminal receive information on the numbers of candidate beams of all other TRPs and the terminal, each TRP may configure its own beam switching period so that all the TRPs and the terminal can sequentially measure performance for the respective beam combinations.

Hereinafter, with reference to FIGS. 6A to 7B, exemplary embodiments will be described based on a situation in which there is no backhaul between TRPs or between base stations connected to the TRPs in the MTRP environment, or even if there is a backhaul, it is not easy to transmit information via the backhaul for various reasons. In such a case, information described as being transmitted and received between the TRPs via the backhaul in the exemplary embodiments illustrated in FIGS. 4 and 5 may be transmitted and received via the terminal. FIGS. 6A to 7B illustrate a preliminary procedure for exchanging necessary information between TRPs when each TRP matches a CSI-RS transmission time and configures an appropriate beam switching period to perform joint beam adjustment in the MTRP environment. That is, the exemplary embodiments illustrated in FIGS. 6A to 7B may be performed after the operations according to the exemplary embodiment illustrated in FIG. 3, when it is impossible to exchange information via a backhaul between the TRPs or between base stations connected to the TRPs.

FIG. 6A and FIG. 6B are sequence charts for describing fourth and fifth exemplary embodiments of a beam management method in a communication system.

As shown in FIGS. 6A and 6B, a communication system 600 may include one or more TRPs and one or more terminals. For example, the communication system 600 may include a TRP A 601, a TRP B 602, and a terminal 603. In the communication system 600, the TRP A 601 and TRP B 602 may be connected to different base stations. The TRP A 601 and TRP B 602 may support the same terminal 603. The TRP A 601 and TRP B 602 may perform information transmission and reception to and from each other via the terminal 603. Hereinafter, in describing the fourth and fifth exemplary embodiments of the beam management method in the communication system with reference to FIGS. 6A and 6B, descriptions redundant with those described with reference to FIGS. 1 to 5 may be omitted.

FIG. 6A illustrates a process in which the TRP A 601 transmits information on its CSI-RS transmission time and transmission pattern to the terminal 603, and the terminal 603 receives the information through a UE panel A. Referring to FIG. 6A, the TRP A 601 may transmit information on its TRP ID (e.g. TRP ID_A) and information on a transmission time and transmission pattern of a first reference signal to the terminal 603 (S621).

FIG. 6B illustrates a process in which the terminal 603 retransmits the information on the CSI-RS transmission time and transmission pattern of the TRP A 601 received in the process of FIG. 6A to the TRP B 602 through a UE panel B. Referring to FIG. 6B, the terminal 603 may transmit the information received in step S621, that is, the information on the TRP ID of TRP A 601 and the transmission time and transmission pattern of the first reference signal, to the TRP B 602 (S622).

Specifically, referring to FIG. 6A, in the fourth exemplary embodiment of the beam management method in the communication system, in the situation where the TRP A 601 and TRP B 602 communicate with the UE panel A and UE panel B of the terminal 603, respectively, the TRP A 601 may perform a procedure for transmitting information on its own TRP ID and information on the CSI-RS transmission time and transmission pattern to the terminal 603 through a communication link between the TRP A 601 and the UE panel A. This procedure may be performed identically or similarly to, for example, Table 5.

TABLE 5

| Path | Delivered information |
|---|---|
| TRP A → UE pane A | TRP ID_A, CSI-RS transmission time and |
| | transmission pattern of TRP A |

In FIG. 6A and FIG. 6B, operations for signaling between the TRPs may be performed as in FIG. 4. In this case, unlike in FIG. 4, since information cannot be transmitted via a backhaul between the TRPs or between base stations connected to the TRPs, FIG. 6A may correspond to a process in which the TRP A 601 first transmits information on its CSI-RS transmission time and transmission pattern to the terminal 603. The information on the CSI-RS transmission time and transmission pattern of the TRP A 601 may be transmitted to the terminal 603 by utilizing a parameter CSI-RS-ResourceMapping within a NZP-CSI-RS-Resource IE through RRC reconfiguration. In addition, among information constituting the CSI-RS-ResourceMapping, the information on the CSI-RS transmission time may correspond to firstOFDMSymbolInTimeDomain, and the information on the transmission pattern may correspond to cdm-Type or frequencyDomainAllocation. In addition, the TRP A 601 acting as the reference TRP may transmit information on its CSI-RS transmission time and transmission pattern to the terminal 603 through DCI or other new RRC signaling.

Referring to FIG. 6B, in the fifth exemplary embodiment of the beam management method in the communication system, the terminal 603 may perform a procedure for transmitting the ID of the TRP A 601 and information on the CSI-RS transmission time and transmission pattern of the TRP A 601, which are received from the TRP A 601 in the process or FIG. 6A, to the TRP B 602. This procedure may be performed, for example, identically or similarly to Table 6.

TABLE 6

| Path | Delivered information |
|---|---|
| UE pane B → TRP B | TRP ID_A, CSI-RS transmission time and |
| | transmission pattern of TRP A |

In FIG. 6B, the terminal 603 may transmit information on the CSI-RS transmission time and transmission pattern of the TRP A 601 to the TRP B 602 by utilizing a previously-established communication link between the TRP B 602 and the UE panel B, and then, the TRP B 602 may match its CSI-RS transmission time and transmission pattern with those of the TRP A 601 based on the information received from the terminal 603. In FIG. 6B, since it is assumed that there is only one TRP other than the reference TRP communicating with the terminal 603, the terminal 603 transmits information on the CSI-RS transmission time and transmission pattern of the TRP A 601 only to the TRP B 602, but where three or more TRPs exist, the same information may be transmitted to all other TRPs excluding the TRP A 601 which is the reference TRP. If the TRP B 602 is connected to the same base station as a base station to which the TRP A 601 is connected, the terminal 603 may transmit information on the CSI-RS transmission time and transmission pattern of the TRP A 601 received from the TRP A 601 to the TRP B 602 through UCI, UE assistance information or other new RRC signaling, and if the TRP B 602 is connected to a different base station than the base station to which the TRP A 601 is connected, the terminal 603 may transmit information on the CSI-RS transmission time and transmission pattern of the TRP A 601 to the TRP B 602 through a Msg1 or MsgA, or may transmit the information through UE assistance information of SRB3 or other new SRB3 signaling.

FIGS. 7A and 7B are sequence charts for describing sixth and seventh exemplary embodiments of a beam management method in a communication system.

As shown in FIGS. 7A and 7B, a communication system 700 may include one or more TRPs and one or more terminals. For example, the communication system 700 may include a TRP A 701, a TRP B 702, and a terminal 703. In the communication system 700, the TRP A 701 and TRP B 702 may be connected to different base stations. The TRP A 701 and TRP B 702 may support the same terminal 703. The TRP A 701 and TRP B 702 may perform information transmission and reception to and from each other via the terminal 703. Hereinafter, in describing the sixth and seventh exemplary embodiments of the beam management method in the communication system with reference to FIGS. 7A and 7B, descriptions redundant with those described with reference to FIGS. 1 to 6B may be omitted.

FIG. 7A illustrates a process in which the TRP A 701 and TRP B 702, which communicate with the terminal 703, transmit information on their own TRP IDs and numbers of their candidate beams to the terminal 703. FIG. 7B illustrates a process in which the terminal 703, based on the information received in FIG. 7A, transmits information on the number of its own candidate beams, the TRP ID of the TRP B 702, and the number of candidate beams of the TRP B 702 to the TRP A 701, and transmits information on the number of its own candidate beams, the TRP ID of the TRP A 701, and the number of candidate beams of the TRP A 701 to the TRP B 702. Then, based on the information received from the terminal 703, the TRP A 701 and TRP B 702 may identify the entire beam combinations and configure their beam switching periods.

Referring to FIG. 7A, in the sixth exemplary embodiment of the beam management method in the communication system, the TRP A 701 may transmit information on its TRP ID and the number of its candidate beams to the terminal 703 (S724). Referring to FIG. 7A, in the sixth exemplary embodiment of the beam management method in the communication system, the TRP B 702 may transmit information on its TRP ID and the number of its candidate beams to the terminal 703 (S725).

The terminal 703 may transmit the information received in step S725, that is, the TRP ID and the number of candidate beams of the TRP B 702, to the TRP A 701 (S726). The terminal 703 may transmit the information received in step S724, that is, the TRP ID and the number of candidate beams of the TRP A 701, to the TRP B 702 (S727). The TRP A 701 and TRP B 702 may each configure their own beam switching periods (S728, S729). The operations according to steps S726 to S729 may be identical or similar to the operations according to steps S726 to S729 described with reference to FIG. 7B.

Referring to FIG. 7A, in the sixth exemplary embodiment of the beam management method in the communication system, in a situation where the TRP A 701 and TRP B 702 respectively communicate with the UE panel A and UE panel B of the terminal 703, the TRP A 701 and TRP B 702 may perform procedures for transmitting information on their own TRP IDs and the numbers of their own candidate beams to the terminal 703 through the communication link between the TRP A 701 and the UE panel A and the communication link between the TRP B 702 and the UE panel B, respectively. The above-described procedures may be performed identically or similarly to, for example, Table 7.

TABLE 7

| Path | TRP ID | Delivered information |
|---|---|---|
| TRP A → UE panel A | TRP ID_A | Number of candidate beams |
| | | of TRP A |
| TRP B → UE panel B | TRP ID_B | Number of candidate beams |
| | | of TRP B |

In FIGS. 7A and 7B, signaling operations for the similar purposes as in FIG. 5 may be performed. In this case, since information cannot be transmitted via a backhaul between the TRPs or between base stations connected to the TRPs unlike the process of FIG. 5, FIG. 7A corresponds to a process in which the TRP A 701 and TRP B 702 first transmit information on their TRP IDs and the numbers of their candidate beams to the terminal 703. When there are three or more TRPs communicating with the terminal 703, all TRPs communicating with the terminal 703 may transmit information on their TRP IDs and information on the numbers of their candidate beams to the terminal 703. The TRP A 701, which is the reference TRP, may transmit information on its own TRP ID to the terminal 703 through an SIB, DCI, RRC reconfiguration, or other new RRC signaling, and may transmit information on the number of its own candidate beams by utilizing a parameter NZP-CSI-RS-ResourceId within a NZP-CSI-RS-ResourceSet IE through RRC reconfiguration, or through an SIB, DCI, or other new RRC signaling. If the TRP B 702 is connected to the same base station as the base station to which the TRP A 701 is connected, similarly to the TRP A 701, the TRP B 702 may transmit information on its TRP ID to the terminal 703 through an SIB, DCI, RRC reconfiguration, or other new RRC signaling, and may transmit information on the number of its candidate beam s by utilizing a parameter NZP-CSI-RS-ResourceId with in an NZP-CSI-RS-ResourceSet IE through RRC reconfiguration, or through an SIB, DCI, or other new RRC signaling. In addition, if the TRP B 702 is connected to a different base station than the base station to which the TRP A 701 is connected, the TRP B 702 may transmit information on its own TRP ID and information on the number of its candidate beams through an SIB, DCI, Msg2,MsgB, or other new SRB3 signaling.

Referring to FIG. 7B, in the seventh exemplary embodiment of the beam management method in the communication system, based on the information received in the process of FIG. 7A, the terminal 703 may perform a procedure of transmitting information on the TRP ID and the number of candidate beams of the TRP A 701 to the TRP B 702, and conversely transmitting information on the TRP ID and the number of candidate beams of the TRP B 702 to the TRP A 701. In addition, the terminal 703 may perform a procedure of transmitting information on the number of its own candidate beams information to all TRPs. The above-described procedure may be performed identically or similarly to, for example, Table 8.

TABLE 8

| Path | Delivered information |
|---|---|
| UE panel A → TRP A | Number of candidate beams of terminal, and TRP |
| | ID_B & number of candidate beams of TRP B |
| UE panel B → TRP B | Number of candidate beams of terminal, and TRP |
| | ID_A & number of candidate beams of TRP A |

In FIG. 7B, the terminal 703 may transmit information on the TRP ID and the number of candidate beams of other TRPs and information on the number of its own candidate beams respectively to the TRP A 701 and TRP B 702 by utilizing the communication link between the TRP A 701 and the UE panel A and the communication link between the TRP B 702 and the UE panel B, which are previously established with the TRP A 701 and TRP B 702. Then, the TRP A 701 and TRP B 702 may set their own beam switching periodicities based on the received information. The above-described operation may be performed identically or similarly to, for example, Table 9.

TABLE 9

| TRP | Beam switching period |
|---|---|
| TRP A | 5 |
| TRP B | 1 |

FIG. 7B illustrates an example in which the terminal 703 transmits information a TRP ID and the number of candidate beams for one TRP to each of the TRP A 701 and TRP B 702. However, when there are three or more TRPs communicating with the terminal 703, the terminal 703 may transmit information on TRP IDs and numbers of candidate beams for all other TRPs communicating with itself excluding the TRP A 701 to the TRP A 701, and transmit such information to the remaining TRPs in the same manner. In addition, although the present disclosure considers a case where the terminal 703 has only one candidate beam, if it is assumed that the terminal 703 has multiple beams instead of just one beam, the same scheme as the environment where three TRPs exist in FIG. 5 may be used, for example, if the beam switching priorities are configured as an order of the TRP A 701, TRP B 702, and terminal 703, the terminal 703 may configure its beam switching period to 1, the TRP B 702 may configure its beam switching period corresponding to the number of beams of the terminal 703, and the TRP A 701 may configure its beam switching period to the number of beam combinations of the TRP B 702 and the terminal 703. As a result, each TRP may configure its beam switching period in the same manner as in FIG. 5 based on the information received from the terminal 703, and FIG. 7B shows an example in which the TRP A 701 configure its beam switching period to 5 and configures the TRP B's beam switching period to 1, similarly to FIG. 5. The terminal 703 may transmit information on the TRP ID and number of candidate beams, which is received from the TRP B 702, and information on the number of its own candidate beams to the TRP A 701 through UCI, UE Assistance information, or other new RRC signaling. If the TRP B 702 is connected to the same base station as the base station to which the TRP A 701 is connected, the terminal 703 may transmit information on the TRP ID and number of candidate beams, which is received from the TRP A 701, and information on the number of its own candidate beams to the TRP B 702 through UCI, UE assistance information, or other new RRC signaling, in the same manner as in the case of the TRP A 701. If the TRP B 702 is connected to a different base station than the base station to which the TRP A 701 is connected, the terminal 703 may information on the TRP ID and number of candidate beams, which is received from the TRP A 701, and information on the number of its own candidate beams to the TRP B 702 through a Msg1 or MsgA, or through UE assistance information of SRB3 or other new SRB3 signaling.

Additionally, after all TRPs configure beam switching periods, if a process is needed in which it is necessary to determine whether all TRPs have properly configure beam switching periods, all TRPs may transmit information on their configured beam switching periods to the reference TRP via the terminal 703, and the reference TRP may determine whether all the TRPs have properly configure beam switching periods based on the beam switching periods received from other TRPs and the beam switching priorities of the TRPs. When the beam switching period configured by the TRP B 702 needs to be transmitted to the terminal 703, if the TRP B 702 is connected to the same base station as the base station to which the TRP A 701 is connected, the TRP B 702 may transmit information on the configured beam switching period to the terminal 703 by transmitting information on the number of repetitions of the configured beam by utilizing information ‘ENUMERATED {on, off}’ of a parameter repetition within a NZP-CSI-ResourceSet IE through the existing RRC reconfiguration, or transmit information on the configured beam switching period to the terminal 703 by newly defining a parameter nrofRepetition, which is information on how many times to repeat one beam with in the NZP-CSI-RS-ResourceSet IE. Alternatively, the TRP B may transmit the information to the terminal 703 through DCI or other new RRC signaling. When the configured beam switching period needs to be transmitted to the terminal 703, if the TRP B 702 is connected to a different base station than the base station to which the TRP A 701 is connected, information on the beam switching period may be transmitted through DCI, Msg2, MsgB, or other new SRB3 signaling. When the terminal 703 transmits the beam switching periods of other TRPs to the TRP A 701, which is the reference TRP, the terminal 703 may transmit them through UCI or UE assistance information or other new RRC signaling as described above.

Referring to the exemplary embodiments illustrated in FIGS. 6A to 7B, FIGS. 6A and 6B illustrate a procedure where the TRP A, acting as the reference TRP, transmits its CSI-RS transmission time and pattern information to other TRPs via the terminal to synchronize the CSI-RS transmission times of the respective TRPs during the joint beam adjustment process in the MTRP environment. FIGS. 7A and 7B illustrate a process in which all TRPs communicating with the terminal transmit their own TRP IDs and information on the numbers of candidate beams to all other TRPs via the terminal. After receiving information on the number of the terminal's candidate beams, as well as the TRP ID and the numbers of candidate beams of other TRPs, each TRP may identify the entire beam combinations based on these information and configure its beam switching period accordingly.

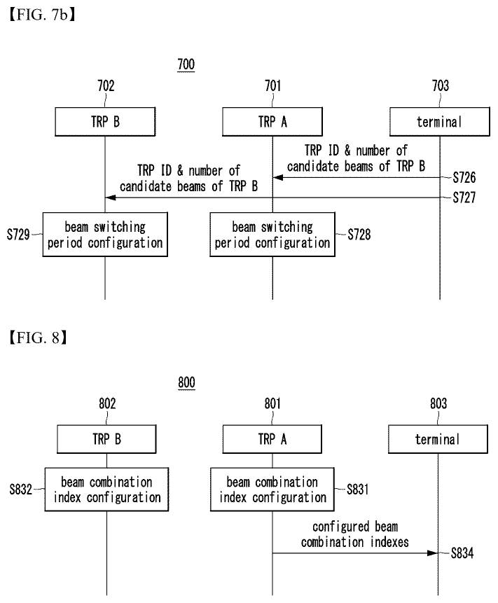

FIG. 8 is a flowchart for describing an eighth embodiment of a beam management method in a communication system.

As shown in FIG. 8, a communication system 800 may include one or more TRPs and one or more terminals. For example, the communication system 800 may include a TRP A 801, a TRP B 802, and a terminal 803. In the communication system 800, the TRP A 801 and TRP B 802 may be connected to the same base station. Alternatively, in the communication system 800, the TRP A 801 and TRP B 802 may be connected to different base stations. The TRP A 801 and TRP B 802 may support the same terminal 803. Hereinafter, in describing the eighth exemplary embodiment of the beam management method in the communication system with reference to FIG. 8, descriptions redundant with those described with reference to FIGS. 1 to 7B may be omitted.

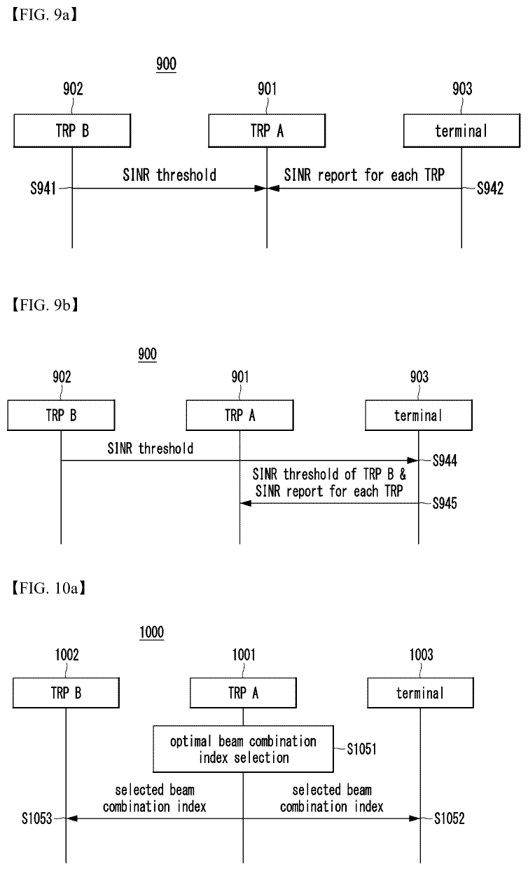

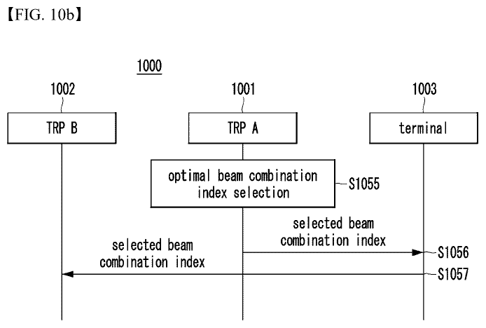

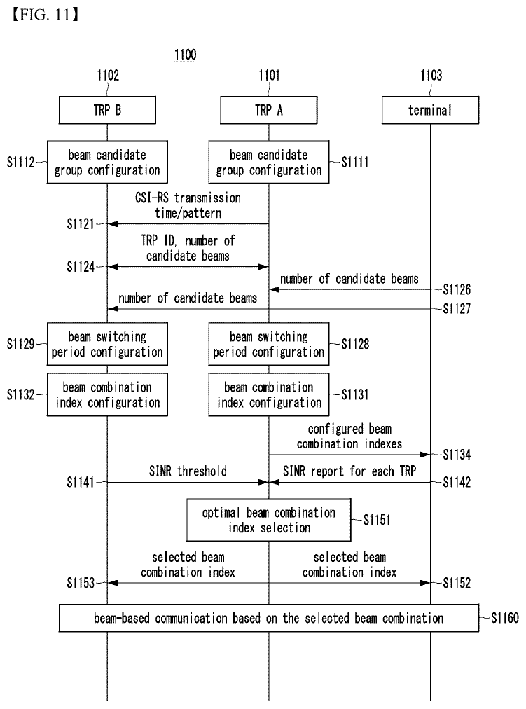

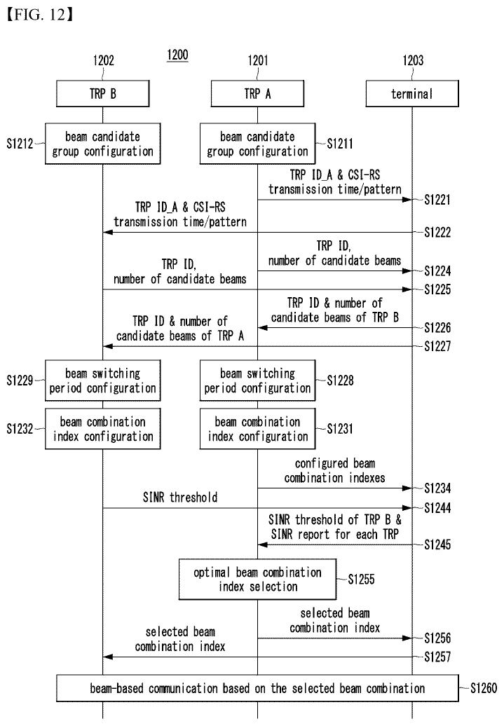

In an exemplary embodiment of the communication system 800, the TRP A 801, acting as a reference TRP, may transmit information on its CSI-RS transmission time and transmission pattern to other TRPs, allowing all the TRPs to transmit CSI-RSs at the same time. Furthermore, based on the information exchanged among the TRPs, each TRP communicating with the terminal 803 may configure an appropriate beam switching period to measure performance across all beam combinations. Subsequently, the terminal 803 may measure performance of each beam combination transmitted by the TRP A 801 and TRP B 802, report results to the TRP A 801 that is the reference TRP, and the TRP A 801 may select an optimal beam for the MTRP environment based on the reported information. FIG. 8 illustrates a process in which each TRP communicating with the terminal 803 assigns a combination index to each beam combination based on the entire beam combinations identified through the procedure of FIG. 5 or FIG. 7B. FIGS. 9A and 9B illustrate a process in which the terminal 803 measures SINRs for beams transmitted by the TRP A 801 and TRP B 802 at the UE panel A and UE panel B, respectively, and report the measured SINRs to the TRP A 801 acting as the reference TRP. In this case, when the TRP A 801 selects an optimal beam for the MTRP environment based on the information reported by the terminal 803, the TRP B 802 may transmit its SINR threshold to the terminal 803 either via the backhaul between the TRPs or base stations connected to the TRPs, or via the terminal 803 as an intermediate forwarder, in order to ensure that the performance of the communication link between the TRP B 802 and UE panel B meets a certain level. FIGS. 10A and 10B illustrate a process in which the TRP A 801 selects an optimal beam combination for the MTRP environment based on the performance of its own beam and that of the TRP B 802, which are measured by the terminal 803 for each beam combination. In summary, the previous procedures served as preliminary steps to configure simultaneous CSI-RS transmission by each TRP and to set appropriate beam switching times during the integrated beam adjustment process in the MTRP environment. However, the procedures from FIG. 8 to FIGS. 10A and 10B may correspond to a process in which each TRP transmits candidate beams through CSI-RSs, the terminal 803 measures the performance of each beam combination, and ultimately, the reference TRP, TRP A 801, selects the optimal beam combination for the MTRP environment based on these measurements. Consequently, the process in FIG. 8 and subsequent processes may be a procedure in which the SINR thresholds for all TRPs and the SINR values for all beam combinations of all TRPs are transmitted to the reference TRP, TRP A 801, and the TRP A 801 then comprehensively assesses the performance of all TRPs within the MTRP environment and selects the optimal beam for all TRPs and the terminal 803, considering the combined performance across all TRPs.

In the eighth exemplary embodiment of the beam management method in the communication system, the TRP A 801 may perform a beam combination index configuration operation (S831). The TRP B 802 may perform a beam combination index configuration operation (S832). The TRP A 801 may transmit information on beam combination indexes configured in step S831 to the TRP A 801 (S831).

Specifically, the TRP A 801 and TRP B 802 may perform a procedure of assigning a combination index to each beam combination by utilizing the entire beam combinations identified through the process of FIG. 5 or FIG. 7B and transmitting results to the terminal 803. The above-described procedure may be performed identically or similarly to, for example, Table 10.

TABLE 10

| | | |
|---|---|---|
| Combination index | | |
| (4 bits) | Beam of TRP A | Beam of TRP B |

| | | | |
|---|---|---|---|
| #1 | (0000) | TRP beam #A-1 | TRP beam #B-1 |
| #2 | (0001) | TRP beam #A-1 | TRP beam #B-2 |
| #3 | (0010) | TRP beam #A-1 | TRP beam #B-3 |

| | | |
|---|---|---|
| . . . | . . . | . . . |

| | | | |
|---|---|---|---|
| #5 | (0100) | TRP beam #A-1 | TRP beam #B-5 |
| #6 | (0101) | TRP beam #A-2 | TRP beam #B-1 |

| | | |
|---|---|---|
| . . . | . . . | . . . |

| | | | |
|---|---|---|---|
| #10 | (1001) | TRP beam #A-2 | TRP beam #B-5 |
| #11 | (1010) | TRP beam #A-3 | TRP beam #B-1 |

| | | |
|---|---|---|
| . . . | . . . | . . . |

| | | | |
|---|---|---|---|
| #15 | (1110) | TRP beam #A-3 | TRP beam #B-5 |

All TRPs communicating with the terminal 803 may determine the total number of beam combinations that can be formed when communicating with the terminal 803 based on the information on the number of candidate beams of other TRPs, and all the TRPs may calculate how many bits to allocate to represent each beam combination based thereon. For example, when the total number of beam combinations is n, ceil(log₂ n) bits (1 bit when n=1) may be allocated. FIG. 8 illustrate an example where the total number of beam combinations that the TRP A 801 and TRP B 802 can form is 15, and therefore 4 bits are allocated to represent each beam combination. Since the two TRPs know the number of each other's candidate beams, they may form the same beam combinations as in FIG. 8. If the number of candidate beams that can be utilized by the terminal 803 in the same situation is 2, the total number of beam combinations that can be formed by the TRP A 801, TRP B 802, and terminal 803 may be 30. In FIG. 8, a TRP beam #A-X and a TRP beam #B-Y represent the X-th and Y-th beams transmitted by the TRP A 801 and TRP B 802, respectively, in the joint beam adjustment process. If the procedure of FIG. 8 is interpreted from the perspective of the TRP A 801, the TRP A 801 may assign combination indexes from 1 to 5 to candidate beams which the TRP A first used in the joint beam adjustment process, combination indexes from 6 to 10 to candidate beams which the TRP A second used in the joint beam adjustment process, and assign combination indexes from 11 to 15 to candidate beams which the TRP A third used. Therefore, the TRP A may respectively assign multiple combination indexes to its own candidate beams, taking into account the candidate beams of the other TRP, to identify which of its own candidate beams has been selected when a specific beam combination is finally selected. In addition, the process considered the case where each of the UE panel A and UE panel B has one beam, but it may be extended to the case where each panel has two or more beams. As a result, when a specific beam combination is finally selected through the joint beam adjustment process, each TRP may identify the optimal beam through a mapping relationship between the combination indexes and the beams. The TRP A 801 may transmit information on the beam combinations of the two TRPs to the terminal 803 through new RRC signaling. In summary, the process of FIG. 8 may be regarded as a process of assigning combination indexes to all possible beam combinations in each TRP and transmitting information on the combination indexes to the terminal 803, and transmitting information on the combination index to the terminal 803, in order to exchange performance for each beam combination with the terminal 803 in the subsequent joint beam adjustment process, and determine which candidate beam the selected combination corresponds to.

FIGS. 9A and 9B are sequence charts for describing ninth and tenth exemplary embodiments of a beam management method in a communication system.

As shown in FIGS. 9A and 9B, a communication system 900 may include one or more TRPs and one or more terminals. For example, the communication system 900 may include a TRP A 901, a TRP B 902, and a terminal 903. In the communication system 900, the TRP A 901 and TRP B 902 may be connected to the same base station. Alternatively, in the communication system 900, the TRP A 901 and TRP B 902 may be connected to different base stations. The TRP A 901 and TRP B 902 may support the same terminal 903. Hereinafter, in describing the ninth and tenth exemplary embodiments of the beam management method in the communication system with reference to FIGS. 9A and 9B, descriptions redundant with those described with reference to FIGS. 1 to 8 may be omitted.

Referring to FIG. 9A, in the ninth exemplary embodiment of the beam management method in the communication system, the TRP B 902 may transmit information on a first threshold value (e.g. SINR threshold value) to the TRP A 901 (S941). The terminal 903 may report first measurement values (e.g. SINR values) for signals received from the TRP A 901 and TRP B 902 to the TRP A 901 (S942).

Referring to FIG. 9B, in the tenth exemplary embodiment of the beam management method in the communication system, the TRP B 902 may transmit information on the first threshold value (e.g. SINR threshold value) to the terminal 903 (S944). The terminal 903 may report information on the first threshold received from the TRP B 902 and first measurement values (e.g. SINR values) for signals received from the TRP A 901 and TRP B 902 to the TRP A 901 (S945).

The information reported in step S942 or step S945 may have a form identical or similar to, for example, Table 11.

TABLE 11

| | | |
|---|---|---|
| Combination index | SINR value | SINR value |
| (4 bits) | (UE panel A) | (UE panel B) |

| | | | |
|---|---|---|---|
| #1 | (0000) | SINR_79 | SINR_75 |
| #2 | (0001) | SINR_107 | SINR_60 |
| #3 | (0010) | SINR_62 | SINR_98 |

| | | |
|---|---|---|
| . . . | . . . | . . . |

| | | | |
|---|---|---|---|
| #14 | (1101) | SINR_88 | SINR_100 |
| #15 | (1110) | SINR_95 | SINR_102 |

FIGS. 9A and 9B illustrate a process in which the terminal 903 measures SINR values at the UE panel A and UE panel B for each beam combination transmitted by the TRP A 901 and reports the same to the TRP A 901 acting as the reference TRP. In the present disclosure, the optimal beam is selected based on the SINR values for the beam combination, but a process of selecting the optimal beam according to other criteria may also be considered. For example, the optimal beam may be selected by considering a latency requirement of the terminal 903 or mobility of the terminal 903. When considering the latency requirement of the terminal 903, a beam supporting higher performance in terms of user experienced data rate may be selected, and when considering the mobility of the terminal 903, a beam that can transmit data to the terminal 903 for a longer period of time based on UE mobility or trajectory may be selected. In addition, when considering channel stability, it is also possible to select a beam with the smallest change in the value of the measured SINR. The process of reporting the performance of the two TRPs to the TRP A 901 is for in the TRP A 901 acting as the reference TRP to select the optimal beam combination for the MTRP environment by considering the performance of both the TRPs. In order for the TRP A 901 to consider the performance of both TRPs, the TRP B 902 may transmits its SINR threshold value to the TRP A 901 via the backhaul between the TRPs or between base stations connected to the TRPs or via the terminal 903 so that when the TRP A 901 finally selects a beam combination, the selected beam combination can guarantee a certain level or higher performance of the communication link between itself and the terminal 903. When the backhaul between the TRPs or between base stations connected to the TRPs is available, information on the SINR threshold may be transmitted from the TRP B 902 to the TRP A 901 via the backhaul between the TRPs or between base stations connected to the TRPs. On the other hand, in a situation where the backhaul is not available between the TRPs or between base stations connected to the TRPs, if the TRP B 902 is connected to the same base station as the base station to which the TRP A 901 is connected, the TRP B 902 may transmit information on its SINR threshold to the terminal 903 through an SIB, DCI, or other new RRC signaling. If the TRP B 902 is connected to a different base station from the base station to which the TRP A 901 is connected, the TRP B 902 may transmit information on its SINR threshold through an SIB, DCI, Msg2, MsgB, or other new SRB3 signaling. Thereafter, the terminal 903 may transmit information on the received SINR threshold of the TRP B 902 to the TRP A 901 through UCI, UE assistance information, or other new RRC signaling. In addition, the combination indexes in FIGS. 9A and 9B represent the combination indexes for the respective beam combinations configured in FIG. 8, and the SINR value (at the UE panel A) represents the SINR value of the communication link between the TRP A 901 and the UE panel A when the terminal 903 receives a beam corresponding to a specific beam combination index from the TRP A 901 and TRP B 902, and similarly, the SINR value (at the UE panel B) represents the SINR value of the communication link between the TRP B 902 and the UE panel B. The terminal 903 may transmit the SINR values at the UE panel A and the UE panel B to the TRP A 901 in the process of FIGS. 9A and 9B, and thereafter, the TRP A 901 may select the optimal beam combination for the MTRP environment based on the performance of the respective communication links received from the terminal 903 in the process of FIGS. 10A and 10B. FIG. 9A and FIG. 9B illustrate an example in which SINR values are considered as a criterion for selecting a beam combination. The TRP A 901 may indicate which criterion will be used as a TRP selection criterion through an SIB or other new RRC signaling. The terminal 903 may measure the performance of the communication links established with the TRP A 901 and TRP B 902, respectively, and then transmit information on a combination index # and the SINR values of the communication link established with the TRP A 901 to the TRP A 901 through a CSI-RS reporting process. The process of transmitting information the SINR value of the communication link established with the TRP B 902, rather than the TRP A 901, may be performed as follows: The TRP A 901 may transmit information instructing to report performance of the communication link between the TRP B 902 and the terminal 903 to the terminal 903 through a UEInformationRequest message that is RRC signaling. The terminal 903 may receive this information and then transmit information on the SINR value for the communication link between the TRP B 902 and the UE panel B to the TRP A 901 through a UEInformationResponse message. In addition, the TRP A 901 may transmit the information instructing to report performance of the communication link between the TRP B 902 and terminal 903 to the terminal 903 through an SIB or new RRC signaling, and the terminal 903 may use a measurement report or UE assistance information as a response to the instruction, or new RRC signaling may be defined for such purposes.

FIG. 10A and FIG. 10B are sequence charts for describing eleventh and twelfth exemplary embodiments of a beam management method in a communication system.

As shown in FIGS. 10A and 10B, a communication system 1000 may include one or more TRPs and one or more terminals. For example, the communication system 1000 may include a TRP A 1001, a TRP B 1002, and a terminal 1003. In the communication system 1000, the TRP A 1001 and TRP B 1002 may be connected to the same base station. Alternatively, in the communication system 1000, the TRP A 1001 and TRP B 1002 may be connected to different base stations. The TRP A 1001 and TRP B 1002 may support the same terminal 1003. Hereinafter, in describing the eleventh and twelfth exemplary embodiments of the beam management method in the communication system with reference to FIGS. 10A and 10B, descriptions redundant with those described with reference to FIGS. 1 to 9B may be omitted.

Referring to FIG. 10A, in the eleventh exemplary embodiment of the beam management method in the communication system, the TRP A 1001 may select an optimal beam combination (or its index) (S1051). The TRP A 1001 may transmit information of the selected optimal beam combination (or its index) to the terminal 1003 (S1052). The TRP A 1001 may also transmit information on the selected optimal beam combination (or its index) to the TRP B 1002 (S1053).

Referring to FIG. 10B, in the twelfth exemplary embodiment of the beam management method in the communication system, the TRP A 1001 may select an optimal beam combination (or its index) (S1055). The TRP A 1001 may transmit information on the selected optimal beam combination (or its index) to the terminal 1003 (S1056). The terminal 1003 may then transmit information on the optimal beam combination (or its index) selected by the TRP A 1001 to the TRP B 1002 (S1057).

Specifically, FIGS. 10A and 10A illustrate the process by which the TRP A 1001 selects the optimal beam combination based on the SINR values for the TRP A 1001 and TRP B 1002 and the SINR threshold of the TRP B 1002, which are received through the processes shown in FIGS. 9A and 9B.

TABLE 12

| | | |
|---|---|---|
| Combination index | | |
| (4 bits) | TRP A | TRP A |

| | | | |
|---|---|---|---|
| #1 | (0000) | dissatisfaction | dissatisfaction |
| #2 | (0001) | satisfaction | dissatisfaction |
| #3 | (0010) | dissatisfaction | satisfaction |

| | | |
|---|---|---|
| . . . | . . . | . . . |

| | | | |
|---|---|---|---|
| #14 | (1101) | satisfaction | satisfaction |
| #15 | (1110) | satisfaction | satisfaction |

In Table 12, combination indexes represent combination indexes for the respective beam combinations configured in the process of FIG. 8. A column corresponding to the TRP A 1001 indicates whether the SINR values of the communication link between the TRP A 1001 and the UE panel A satisfies the SINR threshold set by the TRP A 1001. Similarly, a column corresponding to the TRP B 1002 indicates whether the SINR values of the communication link between the TRP B 1002 and the UE panel B satisfies the SINR threshold set by the TRP B 1002. The TRP A 1001, in the process of finally selecting a beam, may first determine whether the SINR values received from the terminal 1003 exceeds the SINR threshold specified by the TRP corresponding to that communication link, to satisfy the minimum requirements configured by each TRP. Then, the TRP A 1001 may assess whether a specific beam combination meets the SINR threshold across all communication links and finally select a beam by considering only those combination indexes that satisfy the criterion. For instance, in FIGS. 10A and 10B, in the case of combination index #2, the SINR threshold set by the TRP A 1001 is satisfied for the communication link between the TRP A 1001 and the UE panel A, but the SINR threshold set by the TRP B 1002 is not satisfied for the communication link between the TRP B 1002 and the UE panel B. Therefore, the TRP A 1001 may exclude the combination index #2when finally selecting a beam combination. Similarly, the combination index #3 may be excluded because the communication link between the TRP A 1001 and the UE panel A does not satisfy the SINR threshold set by the TRP A 1001. In the examples of FIGS. 10A and 10B, the combination indexes #14 and #15 may be considered for final selection, and according to FIGS. 9A and 9B, the combination index #15 may be finally selected as it offers better performance. If, in FIGS. 10A and 10B, both the combination indexes #14 and #15 meet the SINR thresholds of both TRPs, but the combination index #14 provides better performance for the TRP A 1001 and the combination index #15 provides better performance for the TRP B 1002, it may also be considered to select a beam combination that provides a higher overall data transmission rate from the perspective of the terminal 1003. Additionally, if both beam combinations meet the SINR requirements, the optimal beam combination may be selected based on other criteria mentioned earlier in FIGS. 9A and 9B. For instance, when considering a latency requirement of terminal 1003, a beam combination that supports higher performance in terms of user-experienced data rate may be selected. When considering mobility of terminal 1003, a beam combination that can transmit data to terminal 1003 for a longer time based on UE mobility or trajectory may be selected. In addition, when considering channel stability, a beam combination with a smaller variation in the measured SINR value among the selected beam combinations may be selected. The present disclosure primarily considers the case where each of the UE panel A and UE panel B of the terminal 1003 has only one beam, but it may also be extended to cases with two or more beams. Therefore, information on the final selected combination index needs to be transmitted to the terminal 1003. The TRP A 1001 may transmit the finally selected combination index to the terminal 1003 through RRC reconfiguration or other new RRC signaling. The TRP A 1001 may immediately identify its optimal beam from the final selected combination index, whereas the TRP B 1002 may need to receive information on the selected combination index from the TRP A 1001 via the backhaul between the TRPs or between base stations connected to the TRPs, or via the terminal 1003. If the TRP B 1002 receives the information via the backhaul between the TRPs or between base stations connected to the TRPs, the TRP A 1001 may transmit the information to the TRP B 1002 via the backhaul. Conversely, if the TRP B 1002 receives the information via the terminal 1003, the terminal 1003 may transmit information on the combination index received from the TRP A 1001 to the TRP B 1002. When the terminal 1003 transmits the information on the finally selected beam combination index to the TRP B 1002, if the TRP B 1002 is connected to the same base station as the base station to which the TRP A 1001 is connected, the terminal 1003 may transmit information on the finally selected beam combination index to the TRP B 1002 through UCI, UE assistance information, or other new RRC signaling. If the TRP B 1002 is connected to a different base station from the base station to which the TRP A 1001 is connected, the terminal 1003 may transmit information on the finally selected beam combination index to the TRP B 1002 through a Msg1 or MsgA, or through UE assistance information or other new SRB3 signaling. Thereafter, as described in FIG. 8, the TRP B 1002 may determine which beam from its candidate beam has been selected through the integrated beam coordination process based on the finally selected combination index. Through this process, all the TRPs and terminal 1003 may subsequently communicate using the optimal beam selected through the integrated beam coordination process.

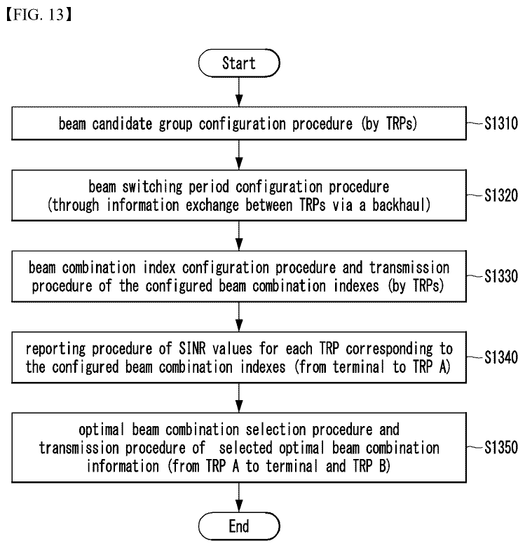

FIG. 11 is a sequence chart for describing a first exemplary embodiment of a beam adjustment method in a communication system.

As shown in FIG. 11, a communication system 1100 may be the same as or similar to the communication systems 300, 400, 500, 800, 900, and 1000 described with reference to FIGS. 3, 4, 5, 8, 9A, and 10A. The communication system 1100 may include one or more TRPs and one or more terminals. For example, the communication system 1100 may include a TRP A 1101, a TRP B 1102, and a terminal 1103. In the communication system 1100, the TRP A 1101 and TRP B 1102 may be connected to the same base station. The TRP A 1101 and TRP B 1102 may perform mutual information transmission and reception via a backhaul or the like. The TRP A 1101 and TRP B 1102 may support the same terminal 1103. Hereinafter, in describing the first exemplary embodiment of the beam adjustment method in the communication system with reference to FIG. 11, descriptions redundant with those described with reference to FIGS. 1 to 10B may be omitted.

The TRP A 1101 may perform a beam candidate group configuration operation (S1111). The TRP B 1102 may perform a beam candidate group configuration operation (S1112). The operations according to steps S1111 and S1112 may be identical or similar to the operations according to steps S311 and S312, described with reference to FIG. 3.

The TRP A 1101 may transmit information on a transmission time, transmission pattern, and similar details of a first reference signal (S1121). The TRP B 1102 may receive information on the transmission time, transmission pattern, and similar details of the first reference signal transmitted by the TRP A 1101 (S1121). The operations according to step S1121 may be identical or similar to the operations according to step S421, described with reference to FIG. 4.

The TRP A 1101 and TRP B 1102 may exchange information on TRP IDs and the number of candidate beams with each other (S1124). The terminal 1103 may transmit information on the number of its candidate beams to the TRP A 1101 and TRP B 1102 (S1126, S1127). The TRP A 1101 and TRP B 1102 may each set their own beam switching cycles (S1128, S1129). The operations according to steps S1124 through S1129 may be identical or similar to the operations according to steps S524 through S529, described with reference to FIG. 5.

The TRP A 1101 may perform a beam combination index configuration operation (S1131). The TRP B 1102 may perform a beam combination index configuration operation (S1132). The TRP A 1101 may transmit information on the beam combination indexes configured in step S1131 to the TRP B 1102 (S1133). The operations according to steps S1131 through S1134 may be identical or similar to the operations according to steps S831 through S834, described with reference to FIG. 8.

The TRP B 1102 may transmit information on a first threshold (e.g. SINR threshold) to the TRP A 1101 (S1141). The terminal 1103 may report first measurement values (e.g. SINR values) for signals received from the TRP A 1101 and TRP B 1102 to the TRP A 1101 (S1142). The operations according to steps S1141 through S1142 may be identical or similar to the operations according to steps S941 through S942, described with reference to FIG. 9A.

The TRP A 1101 may select an optimal beam combination (or its index) (S1151). The TRP A 1101 may transmit information of the selected optimal beam combination (or its index) to the terminal 1103 (S1152). The TRP A 1101 may transmit information of the selected optimal beam combination (or its index) to the TRP B 1102 (S1153). The operations according to steps S1151 through S1153 may be identical or similar to the operations according to steps S1051 through S1053, described with reference to FIG. 10A.

Based on at least some of the operations from steps S1111 through S1150, beam adjustment for beam-based communication between the TRP A 1101, TRP B 1102, and terminal 1103 may be performed. The TRP A 1101, TRP B 1102, and terminal 1103 may perform beam-based communication based on the optimal beam combination (or its index) selected in step S1151 (S1160). That is, the TRP A 1101, TRP B 1102, and terminal 1103 may perform mutual communication using the beams constituting the selected optimal beam combination.

The operation method of the terminal 1103 according to the first exemplary embodiment of the beam adjustment method in the communication system may include a step of transmitting information on one or more candidate beams of the terminal 1103 to the TRP A 1101 and TRP B 1102, a step of receiving information on one or more beam combinations from the TRP A 1101, a step of performing a measurement operation on first signals received from the TRP A 1101 and TRP B 1102 corresponding to each of the one or more beam combinations, a step of transmitting information related to first measurement values for each beam combination obtained based on the measurement operation to the TRP A 1101, and a step of receiving information of a selected first beam combination among the one or more beam combinations from the TRP A 1101 based on the first measurement values for each beam combination. Each of the one or more beam combinations may be a combination of one of the candidate beams of the TRP A 1101, one of the candidate beams of the TRP B 1102, and one of the candidate beams of the terminal 1103.

The step of performing the measurement operation may include a step of receiving the first signals transmitted from the TRP A 1101 and TRP B 1102, and a step of performing the measurement operation on the received first signals. In the step of receiving the first signals, reception timings of the first signals transmitted from the TRP A 1101 and the first signals transmitted from the TRP B 1102 may be aligned.

In the step of receiving the first signals, the first signals transmitted from the TRP A 1101 may be received based on a first period configured according to the information of one or more candidate beams of the TRP A 1101, and the second signals transmitted from the TRP B 1102 may be received based on a second period configured according to the information of one or more candidate beams of the TRP B 1102.

The first measurement values may be Signal to Interference plus Noise Ratio (SINR) values for the first signals. The step of performing the measurement operation may include a step of receiving the first signals transmitted from the TRP A 1101 through a first panel of the terminal 1103 corresponding to the TRP A 1101, a step of receiving the first signals transmitted from the TRP B 1102 through a second panel of the terminal 1103 corresponding to the TRP B 1102, a step of obtaining the first measurement values for each of the received first signals, and a step of mapping the obtained first measurement values to each of the one or more beam combinations.

The first beam combination selected by the TRP A 1101 may comprise at least a first beam from the one or more candidate beams of the TRP A 1101, a second beam from the one or more candidate beams of the TRP B 1102, and a third beam from the one or more candidate beams of the terminal 1103. The operation method of the terminal 1103 may further include, after receiving the information of the first beam combination, a step of performing beam-based communication with the TRP A 1101 and TRP B 1102 based on beams that constitute the first beam combination selected by the TRP A 1101.

The first beam combination selected by the TRP A 1101 may comprise at least a first beam from the one or more candidate beams of the TRP A 1101, a second beam from the one or more candidate beams of the TRP B 1102, and a third beam corresponding to the TRP A 1101 and a fourth beam corresponding to the TRP B 1102 from the one or more candidate beams of the terminal 1103. The operation method of the terminal 1103 may further include, after receiving the information of the first beam combination, a step of performing beam-based communication with the TRP A 1101 and TRP B 1102 based on the beams that constitute the first beam combination selected by the TRP A 1101.

The operation method of the TRP A 1101 according to the first exemplary embodiment of the beam adjustment method in the communication system may include a step of configuring one or more candidate beams of the TRP A 1101, a step of receiving information on one or more candidate beams of the TRP B 1102 from the TRP B 1102, a step of receiving information on one or more candidate beams of the terminal 1103 from the terminal 1103, a step of configuring one or more beam combinations, a step of transmitting information on the one or more beam combinations to the terminal 1103, a step of receiving information on one or more first measurement values for one or more first signals corresponding to each of the one or more beam combinations from the terminal 1103, a step of selecting a first beam combination from the one or more beam combinations based on the information of the first measurement values, and a step of transmitting information of the selected first beam combination to the terminal 1103 and TRP B 1102. Each of the one or more beam combinations may be a combination of one of the candidate beams of the TRP A 1101, one of the candidate beams of the TRP B 1102, and one of the candidate beams of the terminal 1103.

The operation method of the TRP A 1101 may further include, prior to the step of configuring one or more beam combinations, a step of configuring a beam switching period in the TRP A 1101 for beams transmitting the first signals, based on the information on the transmission timing, the information on one or more candidate beams of the terminal 1103, and the information on one or more candidate beams of the TRP B 1102.

The operation method of the TRP A 1101 may further include, prior to the step of configuring one or more beam combinations, a step of transmitting information on the transmission timing of one or more first signals transmitted by the TRP A 1101 to TRP B 1102. The information on the transmission timing may be used to adjust a transmission timing of one or more first signals transmitted by the TRP B 1102.

The first measurement values may be SINR values for the first signals, and the step of selecting the first beam combination may include a step of identifying information on a first threshold value previously received from the second communication node, identifying information on one or more first measurements received from the terminal 1103, and a step of selecting the first beam combination from among one or more beam combinations based on the information of the first threshold value and the information on one or more first measurement values.

The first beam combination may comprise at least a first beam from among one or more candidate beams of the TRP A 1101, a second beam from among one or more candidate beams of the TRP B 1102, and a third beam from among one or more candidate beams of the terminal 1103. The operation method of the TRP A 1101 may further include a step of performing beam-based communication with the terminal 1103 based on the first beam and the third beam among the beams that constitute the first beam combination.

The first beam combination may comprise at least a first beam from among one or more candidate beams of the TRP A 1101, a second beam from among one or more candidate beams of the TRP B 1102, and a third beam corresponding to the TRP A 1101 and a fourth beam corresponding to the TRP B 1102 from among one or more candidate beams of the terminal 1103. The operation method of the TRP A 1101 may further include a step of performing beam-based communication with the terminal 1103 based on the first beam and the third beam among the beams that constitute the first beam combination.

FIG. 12 is a sequence chart for describing a second exemplary embodiment of a beam adjustment method in a communication system.

As shown in FIG. 12, a communication system 1200 may be the same as or similar to the communication systems 300, 400, 500, 800, 900, and 1000 described with reference to FIGS. 3, 4, 5, 8, 9A, and 10A. The communication system 1200 may include one or more TRPs and one or more terminals. For example, the communication system 1200 may include a TRP A 1201, a TRP B 1202, and a terminal 1203. In the communication system 1200, the TRP A 1201 and TRP B 1202 may be connected to different base stations. The TRP A 1201 and TRP B 1202 may support the same terminal 1203. The TRP A 1201 and TRP B 1202 may perform mutual information transmission and reception via the terminal 1203. Hereinafter, in describing the second exemplary embodiment of the beam adjustment method in the communication system with reference to FIG. 12, descriptions redundant with those described with reference to FIGS. 1 to 11 may be omitted.

The TRP A 1201 may perform a beam candidate group configuration operation (S1211). The TRP B 1202 may perform a beam candidate group configuration operation (S1212). The operations according to steps S1211 and S1212 may be identical or similar to the operations according to steps S311 and S312, described with reference to FIG. 3.

The TRP A 1201 may transmit information on its TRP ID (e.g. TRP ID_A) and information on a transmission time, transmission pattern, etc. of a first reference signal to the terminal 1203 (S1221). The operations according to step S1221 may be identical or similar to the operations according to step S621, described with reference to FIG. 6A.

The terminal 1203 may transmit, to the TRP B 1202, the information received in step S1221, specifically the information on the TRP ID and information on the transmission time and transmission pattern of the first reference signal of the TRP A 1201 (S1222). The operations according to step S1222 may be identical or similar to the operations according to step S622, described with reference to FIG. 6B.

The TRP A 1201 may transmit information on its TRP ID and information on the number of its candidate beams to the terminal 1203 (S1224). The TRP B 1202 may transmit information on its TRP ID and the number of its candidate beams to the terminal 1203 (S1225). The operations according to steps S1224 through S1225 may be identical or similar to the operations according to steps S724 through S725, described with reference to FIG. 7A.

The terminal 1203 may transmit, to the TRP A 1201, the information received in step S1225, specifically the information on the TRP ID and number of candidate beams of the TRP B 1202 (S1226). The terminal 1203 may transmit, to the TRP B 1202, the information received in step S1224, specifically the information on the TRP ID and number of candidate beams of the TRP A 1201 (S1227). The TRP A 1201 and TRP B 1202 may each set their own beam switching cycles (S1228, S1229). The operations according to steps S1226 through S1229 may be identical or similar to the operations according to steps S726 through S729, described with reference to FIG. 7B.

The TRP A 1201 may perform a beam combination index configuration operation (S1231). The TRP B 1202 may perform a beam combination index configuration operation (S1232). The TRP A 1201 may transmit information on beam combination indexes configured in step S1231 to the TRP B 1202 (S1233). The operations according to steps S1231 through S1234 may be identical or similar to the operations according to steps S831 through S834, described with reference to FIG. 8.

The TRP B 1202 may transmit information on a first threshold (e.g. SINR threshold) to the terminal 1203 (S1244). The terminal 1203 may report, to the TRP A 1201, information of the first threshold received from the TRP B 1202 and information of first measurement values (e.g. SINR values) for signals received from the TRP A 1201 and TRP B 1202 (S1245). The operations according to steps S1244 through S1245 may be identical or similar to the operations according to steps S944 through S945, described with reference to FIG. 9B.

The TRP A 1201 may select an optimal beam combination (or its index) (S1255). The TRP A 1201 may transmit information of the selected optimal beam combination (or its index) to the terminal 1203 (S1256). The terminal 1203 may transmit information of the optimal beam combination (or its index) selected by the TRP A 1201 to the TRP B 1202 (S1257). The operations according to steps S1255 through S1257 may be identical or similar to the operations according to steps S1055 through S1057, described with reference to FIG. 10B.

Based on at least some of the operations from steps S1211 through S1250, beam adjustment for beam-based communication between the TRP A 1201, TRP B 1202, and terminal 1203 may be performed. The TRP A 1201, TRP B 1202, and terminal 1203 may perform beam-based communication based on the optimal beam combination (or its index) selected in step S1251 (S1260). That is, the TRP A 1201, TRP B 1202, and terminal 1203 may perform mutual communication using beams that constitute the selected optimal beam combination.

The operation method of the terminal 1203 according to the second exemplary embodiment of the beam adjustment method in the communication system may comprise: a step of receiving information on one or more candidate beams of each of the TRP A 1201 and TRP B 1202 from the TRP A 1201 and TRP B 1202, a step of transmitting information on one or more candidate beams of the TRP B 1202 to the TRP A 1201, a step of transmitting information on one or more candidate beams of the TRP A 1201 to the TRP B 1202, a step of receiving information on one or more beam combinations from the TRP A 1201, a step of transmitting information related to first measurement values for each beam combination corresponding to each of the one or more beam combinations to the TRP A 1201, and a step of receiving information on a first beam combination selected by the TRP A 1201 based on the transmitted information related to the first measurement values for each beam combination. Each of the one or more beam combinations may be configured as a combination of at least one of the candidate beams of the TRP A 1201 and one of the candidate beams of the TRP B 1202.

The step of transmitting information related to the first measurement values for each beam combination may comprise a step of receiving first signals transmitted from each of the TRP A 1201 and TRP B 1202 corresponding to each of the one or more beam combinations, a step of performing a measurement operation on the received first signals, and a step of transmitting information related to the first measurement values for each beam combination obtained based on at least the measurement operation to the TRP A 1201. In the step of receiving the first signals, reception timings of the first signals transmitted from the TRP A 1201 and the first signals transmitted from the TRP B 1202 may be aligned.

In the step of receiving the first signals, the first signals transmitted from the TRP A 1201 may be received based on a first period configured based on information on one or more candidate beams of the TRP A 1201, and the second signals transmitted from TRP B 1202 may be received based on a second period configured based on information on one or more candidate beams of the TRP B 1202.

The step of transmitting information related to the first measurement values for each beam combination may comprise a step of receiving information on a first threshold value corresponding to the first measurements from the TRP B 1202 and a step of transmitting to the TRP A 1201 the information on the first threshold value received from the TRP B 1202 and the information on the first measurement values for each beam combination.

The first measurement values may be SINR values for the first signals, and the step of transmitting information related to the first measurement values for each beam combination may comprise: a step of receiving the first signals transmitted from the TRP A 1201 through a first panel of the terminal 1203 corresponding to the TRP A 1201, receiving the first signals transmitted from the TRP B 1202 through a second panel of the terminal 1203 corresponding to the TRP B, a step of obtaining the first measurement values for each of the received first signals, a step of mapping the obtained first measurement values to each of the one or more beam combinations to obtain information on the first measurement values for each beam combination, and a step of transmitting at least the information on the first measurement values for each beam combination to the TRP A 1201.

The operation method of the terminal 1203 may further comprise, prior to the step of receiving information on one or more candidate beams of each of the TRP A 1201 and TRP B 1202, a step of receiving information on a transmission timing of the first signals of the TRP A 1201 from the TRP A 1201 and transmitting the information on the transmission timing of the first signals of the TRP A 1201 to the TRP B 1202.

The operation method of the terminal 1203 may further comprise, prior to the step of receiving information on one or more beam combinations, a step of transmitting information on one or more candidate beams of the terminal 1203 to the TRP A 1201. The first beam combination selected by the TRP A 1201 may comprise a first beam from among one or more candidate beams of the TRP A 1201, a second beam from among one or more candidate beams of the TRP B 1202, and a third beam from among one or more candidate beams of the terminal 1203.

The operation method of the terminal 1203 may further comprise, prior to the step of receiving information on one or more beam combinations, a step of transmitting information on one or more candidate beams of the terminal 1203 to the TRP A 1201. The first beam combination selected by the TRP A 1201 may comprise at least a first beam from among one or more candidate beams of the TRP A 1201, a second beam from among one or more candidate beams of the TRP B 1202, and a third beam corresponding to the TRP A 1201 and a fourth beam corresponding to the TRP B 1202 from among one or more candidate beams of the terminal 1203.

The operation method of the terminal 1203 may further comprise, after the step of receiving information on the first beam combination, a step of transmitting the received information on the first beam combination to the TRP B 1202.

The operation method of the TRP A 1201 according to the second exemplary embodiment of the beam adjustment method in the communication system may comprise: a step of configuring one or more candidate beams of the TRP A 1201, a step of transmitting information on one or more candidate beams of the TRP A 1201 to the terminal 1203, a step of receiving information on one or more candidate beams of the TRP B 1202 from the terminal 1203, a step of configuring one or more beam combinations, a step of transmitting information on one or more beam combinations to the terminal 1203, a step of receiving from the terminal 1203 information related to one or more first measurement values for one or more first signals corresponding to each of the one or more beam combinations, a step of selecting a first beam combination from among the one or more beam combinations based on the information related to the first measurement values, and a step of transmitting the information on the selected first beam combination to the terminal 1203. Each of the one or more beam combinations may be configured as a combination of one beam from among one or more candidate beams of the TRP A 1201 and one beam from among one or more candidate beams of the TRP B 1202.

The operation method of the TRP A 1201 may further comprise, prior to the step of transmitting information on one or more candidate beams, a step of transmitting information related to a transmission timing of one or more first signals of the TRP A 1201 to the terminal 1203.

The operation method of the TRP A 1201 may further comprise, prior to the step of configuring one or more beam combinations, a step of transmitting information on a transmission timing of one or more first signals transmitted by the TRP A 1201 to the terminal 1203, and the information on the transmission timing may be used to adjust a transmission timing of one or more first signals transmitted by the TRP B 1202.

The first measurement values may be SINR values for the first signals, and the information related to one or more first measurement values includes information on a first threshold value corresponding to one or more first measurement values and information on the first measurement values for each beam combination. The step of selecting the first beam combination may comprise a step of identifying information on the second threshold value corresponding to one or more first measurement values previously determined by the TRP A 1201, and a step of selecting the first beam combination from among one or more beam combinations based on the information on the first threshold value, the information on the second threshold value, and the information on the first measurement values for each beam combination.

The operation method of the TRP A 1201 may further comprise, prior to the step of transmitting information on one or more beam combinations, a step of receiving information on one or more candidate beams of the terminal 1203 from the terminal 1203. The first beam combination may comprise a first beam from among one or more candidate beams of the TRP A 1201, a second beam from among one or more candidate beams of the TRP B 1202, and a third beam from among one or more candidate beams of the terminal 1203.

The operation method of the TRP A 1201 may further comprise, prior to the step of transmitting information on one or more beam combinations, a step of receiving information on one or more candidate beams of the terminal 1203 from the terminal 1203. The first beam combination may comprise a first beam from among one or more candidate beams of the TRP A 1201, a second beam from among one or more candidate beams of the TRP B 1202, a third beam corresponding to the TRP A 1201, and a fourth beam corresponding to the TRP B 1202 from among one or more candidate beams of the terminal 1203.

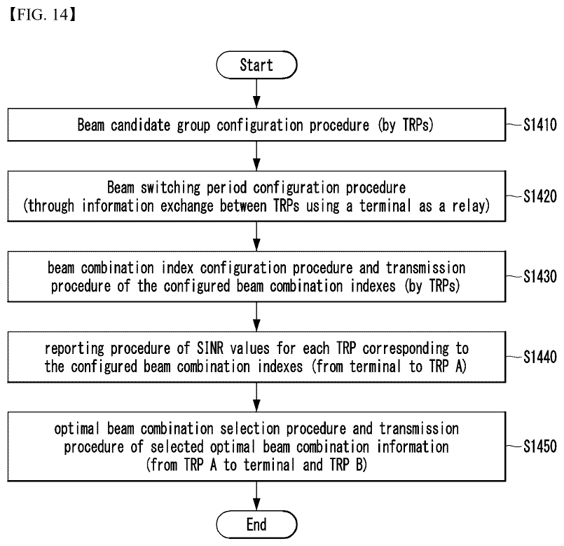

FIG. 13 is a flowchart for describing a first exemplary embodiment of a beam adjustment method in a communication system.

As shown in FIG. 13, a communication system may be the same as or similar to the communication systems 300, 400, 500, 800, 900, and 1000 described with reference to FIGS. 3, 4, 5, 8, 9A, and 10A. The communication system may include one or more TRPs and one or more terminals. For example, the communication system may include a TRP A, a TRP B, and a terminal. In the communication system, the TRP A and TRP B may be connected to the same base station. The TRP A and TRP B may perform mutual information transmission and reception via a backhaul or the like. The TRP A and TRP B may support the same terminal. Hereinafter, in describing the first exemplary embodiment of the beam adjustment method in the communication system with reference to FIG. 13, descriptions redundant with those described with reference to FIGS. 1 to 12 may be omitted.

In the first exemplary embodiment of the beam adjustment method in the communication system, the TRP A and TRP B may perform a beam candidate group configuration procedure (S1310). The operations according to step S1310 may be identical or similar to the operations according to the first exemplary embodiment of the beam management method in a communication system, described with reference to FIG. 3.

The TRP A, TRP B, and terminal may perform a beam switching period configuration procedure (S1320). The beam switching period configuration procedure in step S1320 may be performed based on exchange of information between the TRPs via a backhaul or similar means. The operations according to step S1320 may be identical or similar to the operations according to the second and third exemplary embodiments of the beam management method in a communication system, described with reference to FIG. 4 and FIG. 5.

The TRP A and TRP B may each configure beam combination indexes, and the TRP A may transmit information of the configured beam combination indexes to the terminal and the like (S1330). The operations according to step S1330 may be identical or similar to the operations according to the eighth exemplary embodiment of the beam management method in a communication system, described with reference to FIG. 8.

The TRP A, TRP B, and terminal may perform a procedure for reporting TRP-specific measurement values (e.g. SINR values) (S1340). In step S1340, the terminal may report the TRP-specific measurement values to the TRP A. The operations according to step S1340 may be identical or similar to the operations according to the ninth exemplary embodiment of the beam management method in a communication system, described with reference to FIG. 9A.

The TRP A may select an optimal beam combination and transmit information of the selected optimal beam combination (S1350). In step S1350, the TRP A may transmit information of the selected optimal beam combination to the terminal and TRP B. The operations according to step S1350 may be identical or similar to the operations according to the eleventh exemplary embodiment of the beam management method in the communication system, described with reference to FIG. 10A.

Based on at least some of the operations from steps S1310 through S1350, beam adjustment for beam-based communication between the TRP A, TRP B, and terminal may be performed. The TRP A, TRP B, and terminal may perform beam-based communication based on the optimal beam combination (or its index) selected in step S1350.

FIG. 14 is a flowchart for describing a second exemplary embodiment of a beam adjustment method in a communication system.

As shown in FIG. 14, a communication system may be the same as or similar to the communication systems 300, 400, 500, 800, 900, and 1000 described with reference to FIGS. 3, 4, 5, 8, 9A, and 10A. The communication system may include one or more TRPs and one or more terminals. For example, the communication system may include a TRP A, a TRP B, and a terminal. In the communication system, the TRP A and TRP B may be connected to the same base station. The TRP A and TRP B may perform mutual information transmission and reception via a backhaul or the like. The TRP A and TRP B may support the same terminal. Hereinafter, in describing the second exemplary embodiment of the beam adjustment method in the communication system with reference to FIG. 14, descriptions redundant with those described with reference to FIGS. 1 to 13 may be omitted.

In the second exemplary embodiment of the beam adjustment method in the communication system, the TRP A and TRP B may perform a beam candidate group configuration procedure (S1410). The operations according to step S1410 may be identical or similar to the operations according to the first exemplary embodiment of the beam management method in a communication system, described with reference to FIG. 3.

The TRP A, TRP B, and terminal may perform a beam switching period configuration procedure (S1420). The beam switching period configuration procedure in step S1420 may be performed based on exchange of information between the TRPs via the terminal. The operations according to step S1420 may be identical or similar to the operations according to the fourth, fifth, sixth, and seventh exemplary embodiments of the beam management method in a communication system, described with reference to FIG. 6A, FIG. 6B, FIG. 7A, and FIG. 7B.

The TRP A and TRP B may each configure beam combination indexes, and the TRP A may transmit information of the configured beam combination indexes to the terminal and the like (S1430). The operations according to step S1430 may be identical or similar to the operations according to the eighth exemplary embodiment of the beam management method in a communication system, described with reference to FIG. 8.

The TRP A, TRP B, and terminal may perform a procedure for reporting TRP-specific measurement values (e.g. SINR values) (S1440). In step S1440, the terminal may report the TRP-specific measurement values to the TRP A. The operations according to step S1440 may be identical or similar to the operations according to the tenth exemplary embodiment of the beam management method in a communication system, described with reference to FIG. 9B.

The TRP A may select an optimal beam combination and transmit information of the selected optimal beam combination (S1450). In step S1450, the TRP A may transmit information of the selected optimal beam combination to the terminal and TRP B. The operations according to step S1450 may be identical or similar to the operations according to the twelfth exemplary embodiment of the beam management method in a communication system, described with reference to FIG. 10B.

Based on at least some of the operations from steps S1410 through S1450, beam adjustment for beam-based communication between the TRP A, TRP B, and terminal can be performed. The TRP A, TRP B, and terminal may perform beam-based communication based on the optimal beam combination (or its index) selected in step S1450.

The exemplary embodiments described with reference to FIGS. 11 to 14 are based on the environment in which CSI-RS is used as a reference signal and a TRP selects the optimal beam combination (i.e. downlink (DL) environment). However, this is merely an example for ease of description, and the exemplary embodiments of the beam management method in the communication system are not limited thereto. For instance, at least some of the exemplary embodiments described with reference to FIGS. 3 to 14 may be similarly applied or extended in an uplink (UL) environment.

The exemplary embodiments described with reference to FIGS. 11 to 14 are described based on an MTRP environment where two TRPs (i.e. TRP A and TRP B) support a single terminal. However, this is merely an example for ease of description, and the exemplary embodiments of the beam management method in the communication system are not limited thereto. For instance, at least some of the exemplary embodiments described with reference to FIGS. 3 to 14 may be similarly applied or extended to situations where three or more TRPs communicate with a single terminal.

The exemplary embodiments described with reference to FIGS. 11 to 14 are centered around a situation where the terminal has a single candidate beam. However, this is merely an example for ease of description, and the exemplary embodiments of the beam management method in the communication system are not limited thereto. For instance, at least some of the exemplary embodiments described with reference to FIGS. 3 to 14 may be similarly applied or extended to situations where the terminal has two or more candidate beams. For example, the optimal beam combination may be determined by measuring the performance of the beam combinations formed by the TRP A and TRP B for each beam that the terminal can form.

The exemplary embodiments described with reference to FIGS. 11 to 14 are based on a situation where the TRP A is set as a reference TRP for CSI transmission times of two TRPs, and the TRP A transmits information on its CSI-RS transmission time and transmission pattern to the TRP B, which then aligns its CSI-RS transmission time and pattern with those of the TRP A. However, this is merely an example for ease of description, and the exemplary embodiments of the beam management method in the communication system are not limited thereto. For instance, at least some of the exemplary embodiments described with reference to FIGS. 3 to 14 may be similarly applied or extended to a configuration in which a reference TRP is configured based on TRP IDs (e.g. a TRP with the smaller TRP ID may be configured as the reference TRP). Alternatively, at least some of the exemplary embodiments described with reference to FIGS. 3 to 14 may be similarly applied or extended to a configuration where a reference TRP is configured based on resource utilization (e.g. a TRP with higher resource utilization may be configured as a reference TRP), and a TRP with more available resources may align with the reference TRP in terms of resource utilization. Alternatively, at least some of the exemplary embodiments described with reference to FIGS. 3 to 14 may be similarly applied or extended to a configuration where both TRPs exchange their CSI-RS transmission times and patterns with each other, considering cases where it may be difficult for the TRP B to align its CSI-RS transmission time and pattern with the TRP A.

In an exemplary embodiment of the communication system, a transmission scheme between the TRPs or between the TRPs and the terminal may vary depending on whether all TRPs are connected to the same base station or to different base stations. For instance, if the TRP A and TRP B are connected to the same base station, all TRPs may use an RRC transmission scheme. On the other hand, if the TRP A and TRP B are connected to different base stations, the terminal may establish an RRC connection with only one base station. For example, assuming that the terminal is in an RRC-connected state with the base station connected to the TRP A, the terminal may be regarded as in a multi-connectivity state with the base station connected to the TRP B through a signaling radio bearer 3 (SRB3). The base station connected to the TRP B and the terminal may exchange information such as SN RRC reconfiguration, SN RRC reconfiguration complete, SN management report, and SN UE assistance information through the SRB3.

According to exemplary embodiments of the beam management method and device in the communication system, a beam combination for communication between the terminal and multiple TRPs can be determined based on signaling procedures between the terminal and the multiple TRPs. Information on each TRP's candidate beams (or beam candidate group) can be transmitted and received between the terminal and the multiple TRPs. Through this, one or more beam combinations can be determined. Among the one or more beam combinations thus determined, one beam combination can be selected based on measurement results at the terminal. In the above-described manner, the beam adjustment procedure for communication between the terminal and multiple TRPs can be facilitated.

However, the effects that the exemplary embodiments of the beam management methods and apparatuses can achieve in the communication system are not limited to those mentioned above. Other effects not mentioned are expected to be clearly understood by those skilled in the art in the technical field to which the present disclosure belongs, based on the configurations described in the present disclosure.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. An operation method of a first communication node, comprising:
receiving, from a first transmission and reception point (TRP) and a second TRP, information of one or more candidate beams of each of the first and second TRPs;
transmitting, to the first TRP, information of the one or more candidate beams of the second TRP;
transmitting, to the second TRP, information of the one or more candidate beams of the first TRP;
receiving, from the first TRP, information of one or more beam combinations;
transmitting, to the first TRP, information related to first measurement values for each beam combination corresponding to each of the one or more beam combinations; and
receiving, from the first TRP, information of a first beam combination selected based on the information related to the first measurement values for each beam combination,
wherein each of the one or more beam combinations is configured as a combination of one beam of the one or more candidate beams of the first TRP and one beam of the one or more candidate beams of the second TRP.

2. The operation method according to claim 1, wherein the transmitting of the information related to the first measurement values for each beam combination comprises:
receiving first signals transmitted from the first and second TRPs, the first signals corresponding to each of the one or more beam combinations;
performing a measurement operation on the received first signals; and
transmitting, to the first TRP, the information related to the first measurement values for each beam combination, which is obtained at least based on the measurement operation,
wherein in the receiving of the first signals, reception timings of the first signals transmitted from the first TRP and the first signals transmitted from the second TRP are identical to each other.

3. The operation method according to claim 2, wherein in the receiving of the first signals, the first signals transmitted from the first TRP are received based on a first period configured based on information of the one or more candidate beams of the first TRP, and the second signals transmitted from the second TRP are received based on a second period configured based on information of the one or more candidate beams of the second TRP.

4. The operation method according to claim 1, wherein the transmitting of the information related to the first measurement values for each beam combination comprises:
receiving, from the second TRP, information of a first threshold value corresponding to the first measurement values; and
transmitting, to the first TRP, the information of the first threshold value received from the second TRP and information of the first measurement values for each beam combination.

5. The operation method according to claim 1, wherein the first measurement values are Signal to Interference plus Noise Ratio (SINR) values for the first signals, and the transmitting of the information related to the first measurement values for each beam combination comprises:
receiving the first signals transmitted from the first TRP, through a first panel corresponding to the first TRP in the first communication node;
receiving the first signals transmitted from the second TRP, through a second panel corresponding to the second TRP in the first communication node;
obtaining the first measurement values for each of the received first signals;
mapping the obtained first measurement values to each of the one or more beam combinations to obtain information of the first measurement values for each beam combination; and
transmitting, to the first TRP, at least the information of the first measurement values for each beam combination.

6. The operation method according to claim 1, further comprising:
before receiving the information of the one or more candidate beams of each of the first and second TRPs, receiving, from the first TRP, information related to a transmission timing of the first signals of the first TRP; and
transmitting, to the second TRP, information related to the transmission timing of the first signals of the first TRP.

7. The operation method according to claim 1, further comprising: before receiving the information of the one or more beam combinations, transmitting, to the first TRP, information of one or more candidate beams of the first communication node,
wherein the first beam combination selected by the first TRP comprises a first beam among the one or more candidate beams of the first TRP, a second beam among the one or more candidate beams of the second TRP, and a third beam among the one or more candidate beams of the first communication node.

8. The operation method according to claim 1, further comprising: before receiving the information of the one or more beam combinations, transmitting, to the first TRP, information of one or more candidate beams of the first communication node,
wherein the first beam combination selected by the first TRP comprises at least a first beam among the one or more candidate beams of the first TRP, a second beam among the one or more candidate beams of the second TRP, and a third beam corresponding to the first TRP and a fourth beam corresponding to the second TRP among the one or more candidate beams of the first communication node.

9. The operation method according to claim 1, further comprising: after receiving the information of the first beam combination, transmitting information of the received first beam combination to the second TRP.

10. An operation method of a first transmission and reception point (TRP), comprising:
configuring one or more candidate beams of the first TRP;
transmitting, to a first communication node, information of the one or more candidate beams of the first TRP;
receiving, from the first communication node, information of one or more candidate beams of a second TRP;
configuring one or more beam combinations;
transmitting, to the first communication node, information of the one or more beam combinations;
receiving, from the first communication node, information related to one or more first measurement values for one or more first signals respectively corresponding to the one or more beam combinations;
selecting a first beam combination from among the one or more beam combinations based on the information related to the one or more first measurement values; and
transmitting, to the first communication node, information of the selected first beam combination,
wherein each of the one or more beam combinations is configured as a combination of one beam of the one or more candidate beams of the first TRP and one beam of the one or more candidate beams of the second TRP.

11. The operation method according to claim 10, further comprising: before transmitting the information of the one or more candidate beams, transmitting, to the first communication node, information related to a transmission timing of the one or more first signals of the first TRP.

12. The operation method according to claim 10, further comprising, before configuring the one or more beam combinations, transmitting, to the first communication node, information on a transmission timing of the one or more first signals transmitted from the first TRP, the information on the transmission timing being used to adjust a transmission timing of the one or more first signals transmitted from the second TRP.

13. The operation method according to claim 10, wherein the first measurement values are Signal to Interference plus Noise Ratio (SINR) values for the first signals, the information related to the one or more first measurement values includes information of a first threshold value corresponding to the one or more first measurement values, and information of the first measurement values for each beam combination, and the selecting of the first beam combination comprises:
identifying information of a second threshold value corresponding to the one or more first measurement values, which is predetermined by the first TRP; and
selecting the first beam combination from among the one or more beam combinations based on the information of the first threshold value, the information of the second threshold value, and the information of the first measurement values for each beam combination.

14. The operation method according to claim 10, further comprising: before transmitting the information of the one or more beam combinations, receiving, from the first communication node, information of one or more candidate beams of the first communication node,
wherein the first beam combination comprises a first beam among the one or more candidate beams of the first TRP, a second beam among the one or more candidate beams of the second TRP, and a third beam among the one or more candidate beams of the first communication node.

15. The operation method according to claim 10, further comprising: before transmitting the information of the one or more beam combinations, receiving, from the first communication node, information of one or more candidate beams of the first communication node,
wherein the first beam combination comprises a first beam among the one or more candidate beams of the first TRP, a second beam among the one or more candidate beams of the second TRP, and a third beam corresponding to the first TRP and a fourth beam corresponding to the second TRP among the one or more candidate beams of the first communication node.

16. A first communication node comprising at least one processor, wherein the at least one processor causes the first communication node to perform:
receiving, from a first transmission and reception point (TRP) and a second TRP, information of one or more candidate beams of each of the first and second TRPs;
transmitting, to the first TRP, information of the one or more candidate beams of the second TRP;
transmitting, to the second TRP, information of the one or more candidate beams of the first TRP;
receiving, from the first TRP, information of one or more beam combinations;
transmitting, to the first TRP, information related to first measurement values for each beam combination corresponding to each of the one or more beam combinations; and
receiving, from the first TRP, information of a first beam combination selected based on the information related to the first measurement values for each beam combination,
wherein each of the one or more beam combinations is configured as a combination of one beam of the one or more candidate beams of the first TRP and one beam of the one or more candidate beams of the second TRP.

17. The first communication node according to claim 16, wherein in the transmitting of the information related to the first measurement values for each beam combination, the at least one processor causes the first communication node to perform:
receiving first signals transmitted from the first and second TRPs, the first signals corresponding to each of the one or more beam combinations;
performing a measurement operation on the received first signals; and
transmitting, to the first TRP, the information related to the first measurement values for each beam combination, which is obtained at least based on the measurement operation,
wherein in the receiving of the first signals, reception timings of the first signals transmitted from the first TRP and the first signals transmitted from the second TRP are identical to each other.

18. The first communication node according to claim 16, wherein in the transmitting of the information related to the first measurement values for each beam combination, the at least one processor causes the first communication node to perform:
receiving, from the second TRP, information of a first threshold value corresponding to the first measurement values; and
transmitting, to the first TRP, the information of the first threshold value received from the second TRP and information of the first measurement values for each beam combination.

19. The first communication node according to claim 16, wherein the first measurement values are Signal to Interference plus Noise Ratio (SINR) values for the first signals, and in the transmitting of the information related to the first measurement values for each beam combination, the at least one processor causes the first communication node to perform:
receiving the first signals transmitted from the first TRP, through a first panel corresponding to the first TRP in the first communication node;
receiving the first signals transmitted from the second TRP, through a second panel corresponding to the second TRP in the first communication node;
obtaining the first measurement values for each of the received first signals;
mapping the obtained first measurement values to each of the one or more beam combinations to obtain information of the first measurement values for each beam combination; and
transmitting, to the first TRP, at least the information of the first measurement values for each beam combination.

20. The first communication node according to claim 16, wherein the at least one processor further causes the first communication node to perform:
before receiving the information of the one or more candidate beams of each of the first and second TRPs, receiving, from the first TRP, information related to a transmission timing of the first signals of the first TRP; and
transmitting, to the second TRP, information related to the transmission timing of the first signals of the first TRP.
